(19) United States
(12) Patent Application Publication
(10) Pub. No.: US 2005/0078115 A1
(43) Pub. Date: Apr. 14, 2005

(54) Method for determination of a separation from processor units to at least one reference position in a processor arrangement and processor arrangement

(76) Inventors: Anton Georg Buchmeier, Ottobrunn (DE); Stefan Jung, Munchen (DE); Annelie Stohr, Munchen (DE); Thomas Sturm, Kirchheim (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/496,696

(22) PCT Filed: Nov. 28, 2002
(86) PCT No.: PCT/DE02/04373

(30) Foreign Application Priority Data
Nov. 30, 2001 (DE) 101 58 784.8
Nov. 30, 2001 (DE) 101 58 781.3

(51) Int. Cl. G06F 15/16

(52) U.S. Cl. 345/502

(57) ABSTRACT

A processor arrangement comprises a number of processor units. Each processor unit is coupled to at least one adjacent processor unit by means of a bi-directional communication interface. Messages are exchanged between adjacent processor units for the determination of the separation of a processor unit in the processor arrangement from a reference position. Each message contains separation information, giving the separation of the processor unit receiving the message from the reference position or the separation of the processor unit sending the message from the reference position, where each processor unit is embodied such as to be able to determine or store the separation thereof from the reference position from the separation information in a received message.

### BACKGROUND

The invention relates to a method for the determination of the distance between processor units and at least one reference position in a processor arrangement, and to a processor arrangement.

When a processor arrangement having a large number of processors has been produced in such a way that the local position of the individual processors within the processor arrangement is not known, the individual processors cannot be addressed individually.

However, the processors must be organized before the use of the processor arrangement in order that the local position of the individual processors within the processor arrangement can be determined, and it is thus possible to address the processors individually within the processor arrangement.

It should be possible to carry out the organization process even when faults occur during the course of production of the processor arrangement or even when subsequent failures occur of one or more processors, or of one or more connections between the processors.

One example of a processor arrangement such as this is a pixel arrangement, with one processor being associated with each pixel in the pixel arrangement, and being able to drive that pixel. The pixel may be in the form of an imaging element or else a sensor element, so that the pixel arrangement can be configured as a display unit or as a sensor array.

Considerable problems frequently occur in a pixel arrangement having a large number of pixels, on each page particularly in the case of a large-area dot-matrix display element or a large-area sensor array.

A pixel arrangement such as this has, for example, several million image points, that is to say pixels, on each page for the situation where a so-called “electronic newspaper” is set up.

In the following text, the expression a pixel arrangement means a homogeneous pixel matrix which is driven or addressed from its edges. A display matrix such as this or a sensor matrix, that is to say in general a pixel arrangement such as this, has, for example, active non-linear selection devices such as thin film transistors (TFTs) in liquid crystal display units (LCDs) whose size and dimensions are limited by the characteristics of the thin film transistors as well as by the parasitic resistances of the data lines which are used for transmission of the signals from and to the individual pixels.

In practice, the thin film transistors have to have a current ratio between the current which flows in the on state (Iₒₙ) and the current which flows in the off state (I_{off}) of 10⁵ to 10⁶. High electrical resistances of the very thin and very long data lines in a pixel arrangement such as this as well as a low current in the on state limit the access time to individual rows and columns of the pixels (which are normally arranged in a matrix) in the pixel arrangement.

This leads to the individual pixel elements being electrically charged only very slowly. Furthermore, an excessively high current when the pixel arrangement is in the off state, when the matrix pixel arrangement is being scanned in rows or columns leads to a charge loss of the electrical charges in the pixel capacitors when they are not actually selected. For this reason, the drive cycle, that is to say the time interval between each occasion on which the individual pixel elements in the pixel arrangement are driven, must not be too long.

The problems mentioned above are explained, for example in T. J. Nelson and J. R. Wullert, Electronic Information Display Technologies, World Scientific, Chapter 8.2, 1997 and in K. Amundson, Microencapsulated Electrophoretic Materials for Electronic Paper Displays, International Display Research Conference, 2000 in conjunction with the design of liquid crystal display units and electrophoretic display units with thin film transistors as drive transistors.

Furthermore, the production process for liquid crystal flat screens is extremely complex and susceptible to faults.

The problems described above become even worse in the case of large-area and flexible displays, that is to say in the case of large-area and flexible display units such as those for an electronic newspaper, and in particular in the situation where low-cost production methods such as printing methods for production of printable transistors are used for the switching elements, that is to say for example in the field of polymer electronics. Transistors such as these typically have an Iₒₙ/I_{off} ratio of 10⁴ to 10⁵. In any case, the characteristics of transistors which are designed using polymer electronics are even worse than those of conventional thin film transistors based on silicon. Polymer electronic transistors such as these are, however, suitable only for display units with several hundred image rows and image columns.

One particular problem is that the yield for the production of a pixel arrangement is lower, owing to the very large area. This is due to the increased fault probability in a production process such as this. In other words, this means that the number of faulty pixels, image areas or faulty sensor points, that is to say sensor elements, becomes greater as the area of the pixel arrangement becomes larger.

When handling a very thin, flexible and possibly large-area display element, the probability of new defects or damage occurring during the handling process is also high. In the case of conventional addressing of a matrix pixel arrangement, a defect in the matrix would immediately lead to a row error or a column error or even an entire area of the pixel arrangement would fail.

In the prior art, attempts have been made to solve the problems described above by improving the characteristics of the selection transistors, that is to say in particular the ratio of Iₒₙ to I_{off} and by using better production methods. Attempts have been made to provide protection against, mechanical loading of a flat screen by means of an appropriate housing or else by means of specific packaging.

### SUMMARY

One embodiment of the invention specifies a method for determination of the distance between processors and at least one reference position in a processor arrangement, as well as a processor arrangement, in which at least some of the problems relating to the prior art mentioned above are reduced.

In one method for determination of the distance between processor units and at least one reference position in a processor arrangement having a large number of processor units, each processor unit is coupled by a bidirectional communication interface to at least one processor unit which is adjacent to it. The processor units interchange electronic messages with one another, in particular between mutually directly adjacent processor units. According to the method, a first message is generated by a first processor unit which is located at the at least one reference position. The first message contains first distance information, which includes the distance between the first processor unit and the reference position, or the distance between a second processor unit, which receives the first message, and the reference position. The first message is transmitted from the first processor unit to the second processor unit. The distance between the second processor unit and the reference position is determined or stored as a function of the first distance information. The second processor unit generates a second message, which contains second distance information, which includes the distance between the second processor unit and the reference position, or the distance between a third processor unit, which receives the second message, and the reference position. The second message is transmitted from the second processor unit to the third processor unit. Each of the messages is transmitted via the bidirectional communication interface of the respective mutually directly adjacent processor units. The distance between the third processor unit and the reference position is determined or stored as a function of the second distance information. The storage is carried out locally in a local memory, which is associated with a respective processor unit. The method steps described above are carried out for all the processor units in the pixel arrangement in an appropriate iterative manner.

In principle, any desired reference position may be used, with the reference position in one embodiment being a position at which a portal processor is located, which will be described in the following text, drives the processor units in the processor arrangement, and initiates communication from outside the processor arrangement. Furthermore, the reference position may be a position within the processor arrangement, with a processor unit in this case being arranged at the reference position, and being associated with it. In this case, the reference position is located at the edge, that is to say at the uppermost or lowermost row or the left-hand or right-hand column in the situation where the processor units in the processor arrangement are arranged in the form of a matrix in rows and columns. Information is transmitted in or from the processor arrangement by means of the portal processor, exclusively via at least some of the processor units which are located at the edge of the processor arrangement.

This procedure obviously means that, on the basis of an “introduction processor unit” at the reference position, normally at the edge of the processor arrangement, that is to say at an outer pixel with respect to the processor arrangement, a first distance is allocated, for example, the distance value “1”, which indicates that the initial processor unit is at a distance “1” from the portal processor. In the situation where the distance between the processor unit which is transmitting the message and the reference position is in each case inserted into the message, and is transmitted to the processor unit intended to receive the message, the distance value “1” is transmitted by the first processor unit to the second processor unit in the first message, and the received distance value is incremented by a value “1” by the second processor unit. The incremented value “2” is now stored as the up-to-date second distance value for the second processor unit. The second distance value is incremented by a value “1” and a third distance value is generated, and is transmitted to the third processor unit, where it is stored. The corresponding procedure is carried out for all of the processor units in a corresponding manner, and the distance value which is associated with a respective processor is always updated after reception of a message with distance information, if the received distance value is less than the stored distance value.

A processor arrangement has a large number of processor units. Each processor unit is coupled via a bidirectional communication interface to at least one processor unit which is adjacent to it. In order to determine the respective distance between a processor unit in the processor arrangement and a reference position, messages are interchanged between the respective processor units, between mutually adjacent processor units, with each message containing distance information which indicates the distance between a processor unit transmitting the message or a processor unit receiving the message and the reference position (also referred to as the distance value) and with each processor unit being designed such that its own distance from the reference position can be determined or stored from the distance information in a received message.

In one embodiment of the invention, the global and direct processor drive that is provided according to the prior art and that takes place via row and column lines has been given up.

Owing to the use of only local information and the interchanging of electronic messages in particular between mutually directly adjacent processors, the procedure is very robust with respect to defects and failures occurring in individual processor units or in individual connections between two processor units.

The pixel arrangement, in one embodiment the matrix pixel arrangement, is partitioned into specific areas, for example into image blocks, and an information-processing unit, the pixel processor, is associated with each area. The area may contain one pixel or one sensor, or two or more pixels or sensors, which are each driven by one processor unit. The processors are themselves distributed in a grid which is coarser than the pixels or sensors and, obviously, this corresponds to spatial undersampling. This reduces the problems involved with wiring and addressing via column lines and row lines in the case of a matrix pixel arrangement, since the respective lines which connect the processor units to one another and to a pixel arrangement drive circuit may, according to one embodiment of the invention be designed to be larger, that is to say physically thicker and thus with a lower electrical resistance. Each pixel group processor autonomously drives the corresponding image area, for example, by means of a passive matrix drive or an active matrix drive. The size of the display subunits is chosen such that the problems as described above relating to slow charging of the pixel elements and to the very short time duration between two drive cycles do not occur with a given selection device and a given wiring technique. In principle, any desired routing rules for the image information to be displayed or for the sensor information to be recorded may be implemented in the pixel group processors so that the image information and the sensor information can be “umgeleitet” in the form of electronic data transmission even when defects occur in the display, that is to say in the display device, which means the pixel arrangement (for example in the event of physical destruction, such as a point defect in the case of holes, cracks etc.). This means that the apparatus according to one embodiment of the invention is more tolerant of defects. Thus, according to one embodiment of the invention, a pixel arrangement and a method are provided, by means of which method it is possible in a very simple manner to determine the distance between a respective pixel and a reference position and thus also the local position of a pixel within the pixel arrangement. The determination process is no longer carried out on the basis of global information, but local information, which is in each case interchanged in the form of messages between two mutually adjacent processor units. In other words, this solves the problem of determination of distances by means of self-organization based on local message interchange between mutually adjacent processor units. The self-organization method thus has different distributed local uniform algorithms, which each interchange messages via the respective bidirectional communication interface. In other words, this means that, according to one embodiment of the invention, the distance determination process for self-organization is carried out on the basis of purely local information.

According to one embodiment of the invention, the expression pixel should be understood as meaning both an imaging unit and a sound-generating unit, for example, a liquid crystal screen unit or a polymer electronics display unit, or in general, any type of screen which has a large number of pixels or a loudspeaker which produces a sound wave, or in general any element which produces an electromagnetic wave. Alternatively, the invention may be used in a pixel arrangement in which at least some of the pixels are in the form of sensor elements, that is to say the pixel arrangement in this case at least partially comprises a sensor array. This could also, for example, be a screen unit with a touchpad integrated in it which, in particular, can also be split between a number of image tiles, in other words between a number of image areas, in which case each image area may have an associated processor unit. At least some of the sensors may, in each case be in the form of sound sensors or pressure sensors (for example a piezo-crystal sensor), or alternatively a gas sensor, a vibration sensor, a deformation sensor or a tensile stress sensor.

According to one alternative embodiment of the invention, each processor unit is coupled to at least one pixel, such that the pixel can be controlled by the respective processor unit associated with it.

According to this refinement of the invention, not only the distances between mutually coupled processor units, but also the distances between the respective pixels, are determined. This is an important principle for the routing (which is used in the course of displaying image information) of incoming image information to be displayed to the individual pixels, by which the respective image information is displayed. In a corresponding manner, the distance determination for the pixels also forms the basis for routing of recorded sensor information from the pixel to the external interfaces to, for example, the portal processor.

According to another embodiment of the invention, at least some of the pixels are each in the form of a sensor. In this case, according to the invention, a distance determination process for individual sensor pixels is carried out in a large-area sensor array.

Alternatively or additionally, at least some of the pixels may each be in the form of an imaging element or, in general, an element which produces and transmits electromagnetic waves, for example, an element which generates and transmits sound. In this case, according to one embodiment of the invention, a distance determination process is carried out for individual imaging elements in a large-area, in one case matrix, display.

The processor units may each be arranged in a hexagonal area, in which case each processor unit in each case has six adjacent processor units, which are each coupled to the processor unit via a bidirectional communication interface.

Furthermore, the pixels may themselves have a hexagonal shape.

The use of a hexagonal shape results in a very high packing density in the respective arrangement.

Alternatively, the processor units may each be arranged in a rectangular area, in which case each processor unit in each case has four adjacent processor units, which are each coupled to the processor unit via a bidirectional communication interface.

Furthermore, the pixels may themselves have a rectangular shape.

According to another embodiment of the invention, before determination of the distance between the pixel processors and the reference position, the local positions of the processor units within the processor arrangement are determined in that, on the basis of a processor unit at an introduction point in the processor arrangement, position determination messages (which have at least one row parameter z and one column parameter s which respectively contains the row number and the column number of the processor unit sending the message or the row number and the column number respectively, of the processor unit receiving the message within the processor arrangement) are transmitted to adjacent processor units, and the respective processor unit carries out the following steps:
if the row parameter in the received message is larger than the previously stored row number of the processor unit, then the processor unit's own row number is associated with the row parameter value z of the received message,
if the column parameter in the received message is greater than the processor unit's own column number, then the stored column number is associated with the row parameter value of the received message,
if its own row number and/or its own column number has been changed as a result of the method steps described above, then new position measurement messages with new row parameters and new column parameters are generated, which respectively contain the row number and the column number of the processor unit sending the message, or the row number and the column number of the processor unit receiving the message, and these are transmitted to a respective adjacent processor unit via the bidirectional communication interfaces.

This development further extends the concept according to one embodiment of the invention of the local interchange of messages between mutually adjacent processor units since even the local positions of the individual processor units within the processor arrangement are, according to this concept, based on local position information, which is obtained only from the position information received from the directly adjacent processor unit. This allows a procedure which is very robust with respect to faults for self-organization purposes for the processor arrangement.

According to another embodiment of the invention, the processor unit's own distance value is changed using an iterative method when the previously stored distance value is greater than the received distance value increased by a predetermined value, in the respectively received message, and in the situation where a processor unit changes its own distance value, this processor unit produces a distance measurement message and sends it via all the communication interfaces to adjacent processor units, with the distance measurement message in each case containing its own distance as distance information, or the distance value which the receiving processor unit has from the portal processor.

The distance value can be changed by a value which is increased by a predetermined value than its own distance value, in one case by the value “1”.

According to a further embodiment of the invention, a pixel arrangement is provided which has a large number of pixels, which pixels are grouped to form two or more pixel groups, as well as a large number of processor units.

One processor unit is in each case associated with one pixel group, and controls the pixels in the respective pixel group.

This aspect of the invention can be seen in an obvious manner from the fact that the pixels are grouped to form groups, and in each case one processor unit is responsible for “reading” and “writing” control of the pixels in a group, specifically the pixels in a group which is associated with the processor unit.

In other words, this means that the pixel arrangement, in one case a matrix pixel arrangement, is partitioned into specific areas, for example into image blocks, and each area is associated with an information-processing unit, the pixel processor. The area may contain one pixel or some other element which produces an electromagnetic wave, a sensor or two or more pixels, elements which produce electromagnetic waves, or sensors, which are each driven by one processor unit. The processors are distributed in a coarser grid than the pixels or the sensors themselves which, obviously, corresponds to spatial undersampling. This reduces the problems associated with the wiring and addressing via column lines and row lines in a matrix pixel arrangement, since the respective lines which connect the processor units to one another and to a pixel arrangement drive circuit are larger according to one embodiment of the invention, that is to say they are designed to be physically thicker and thus having a lower electrical resistance. Each pixel group processor drives the corresponding image area autonomously, for example, by means of a passive matrix drive or an active matrix drive. The size of the display subunits is chosen such that the problems described above relating to slow charging of the pixel elements and the very short time duration between two drive cycles do not occur for a given selection device and a given wiring technique. In principle, any desired routing rules for the image information to be displayed or for the sensor information to be recorded can be implemented in the pixel group processors, so that the image information or the sensor information can be “umgeleitet” in the form of an electronic data transmission even when defects occur in the display, that is to say in the display device, which means the pixel arrangement (for example in the event of physical destruction such as a point defect, holes, cracks etc.). This leads to the apparatus according to one embodiment of the invention being more tolerant of defects. Thus, according to one embodiment of the invention, a pixel arrangement and method are provided by means of which method it is possible in a very simple manner to determine the distance between a respective pixel and a reference position, and hence also the local position of a pixel within the pixel arrangement. The determination process is no longer carried out on the basis of global information, but on local information, which is in each case interchanged in the form of messages between two mutually adjacent processor units. In other words, the problem of determining the distance by self-organization based on local message interchange between mutually adjacent processor units is solved. The self-organization method thus, has different, distributed, local uniform algorithms, which interchange the respective messages via the respective bidirectional communication interface. In other words, this means that, according to one embodiment of the invention, the distance is determined on a self-organization basis, based on purely local information.

The hierarchical grouping structure may, according to one embodiment of the invention also be applied to the processor units. In other words, this means that the processor units can themselves also in turn be subdivided into groups, which are controlled by further processor units in a different hierarchy level, with one processor unit in a “controlling” group, in this case always controlling all of the processor units in the “controlled” group.

In other words, this means that a first set of processor units can be associated with first processor groups, and a second set of processor units can be associated with second processor groups. The number of processor units in the first set of processor units is greater than the second set of processor units. The processor units in a second processor group are, according to this refinement of the invention, each coupled only to processor units in a respective first processor group which is associated with them. One processor unit in the first processor group is in each case allocated to a pixel group, and controls the pixels in the respective pixel group.

In this context, it should be noted that any desired number of different sets of processor units may be provided, which may be provided in any desired number of hierarchy levels and may in each case be grouped to form groups of processor units which are themselves controlled by a processor unit which is associated with them. This results in a large number of hierarchy levels thus further increasing the control efficiency of the pixel arrangement.

In one method for determination of the distance between the processor units and at least one reference position in the pixel arrangement having a large number of processor units, each processor unit is coupled via a bidirectional communication interface to at least one processor unit adjacent to it. The processor units interchange electronic messages with one another, in particular between mutually directly adjacent processor units. According to the method, a first message is generated by a first processor unit which is located at the at least one reference position. The first message contains first distance information, which includes the distance between the first processor unit or the distance between a second processor unit which receives the first message and the reference position. The first message is transmitted from the first processor unit to the second processor unit. The distance between the second processor unit and the reference position is determined or stored as a function of the first distance information. The second processor unit generates a second message which contains second distance information, which includes the distance between the second processor unit, or the distance between a third processor unit which receives the second message, and the reference position. The second message is transmitted from the second processor unit to the third processor units. The respective messages are in some cases always transmitted via the bidirectional communication interface of the respectively mutually directly adjacent processor units. The distance between the third processor unit and the reference position is determined or stored as a function of the second distance information. The storage is in each case carried out locally in a local memory, which is associated with a respective processor unit. The method steps described above are carried out for all the processor units in the pixel arrangement correspondingly in an iterative manner.

In principle, the reference position may be any desired position, but is a position at which a portal processor, which will be described in the following text, is located, which drives the processor units in the processor arrangement and initiates the communication from outside the pixel arrangement. Furthermore, the reference position may be a position within the pixel arrangement, with one processor unit in this case being arranged at the reference position and being associated with it. In this case, the reference position is located at the edge, that is to say in the uppermost or lowermost row or the left-hand or right-hand column for the situation where the processor units in the pixel arrangement are arranged in the form of a matrix in rows and columns. The information is transmitted in or from the pixel arrangement by means of the portal processor exclusively via at least some of the processor units which are located at the edge of the pixel arrangement.

This procedure obviously means that, starting from an “introduction processor unit” at the reference position, normally at the edge of the pixel arrangement, that is to say at an outer pixel with respect to the processor arrangement, a first distance is allocated, for example, the distance value “1”, thus indicating that the introduction processor unit is at a distance “1” from the portal processor. In the situation where the distance between the processor unit sending the message and the reference position is in each case inserted into the message and is transmitted to the processor unit that is intended to receive the message, the distance value “1” is transmitted by the first processor unit to the second processor unit in the first message, and the received distance value is incremented by a value “1” by the second processor unit. The incremented value “2” is now stored as the updated second distance value of the second processor unit. The second distance value is incremented by a value “1” and a third distance value is generated, and is transmitted to the third processor unit, where it is stored. The corresponding procedure is carried out for all the processor units in a corresponding manner, and the distance value which is associated with a respective processor is always updated after reception of a message with distance information whenever the received distance value is less than the stored distance value.

The pixel arrangement has a large number of processor units. Each processor unit is coupled via a bidirectional communication interface to at least one processor unit which is adjacent to it. In order to determine the respective distance between a processor unit in the pixel arrangement and a reference position, messages are interchanged between the respective processor units, between mutually adjacent processor units, with each message containing distance information which indicates the distance between a processor unit sending the message or a processor unit receiving the message and the reference position (also referred to as the distance value), and with each processor unit being designed such that its own distance from the reference position can be determined, or can be stored, from the distance information in a received message.

According to this embodiment of the pixel arrangement, the global and direct processor drive which is provided according to the prior art is advantageously based on row and column lines.

As a result of the use of only local information and the interchange of electronic messages in particular between mutually directly adjacent processors, the procedure is very robust with respect to defects and failures which occur in individual processor units or in individual connections between two processor units.

According to one embodiment of the invention, each processor unit is coupled to each processor unit which is in each case directly adjacent to it such that it can interchange electronic messages with the adjacent processor units.

According to this embodiment of the pixel arrangement, not only the distances between mutually coupled processor units but, furthermore, also the distances between the respective pixels, are determined. This is an important principle for routing, which is used for the purpose of displaying image information, of incoming image information to be displayed to the individual pixels, by means of which the respective image information is displayed. In a corresponding manner, distance determination for the pixels also forms a basis for routing of recorded sensor information from the pixel to the external interfaces to, for example, the portal processor.

According to another embodiment of the pixel arrangement, at least some of the pixels are in each case in the form of a sensor. In this case, the distance determination according to the invention is carried out for individual sensor pixels in a large-area sensor array.

Alternatively or additionally, at least some of the pixels may each be in the form of an imaging element. In this case, according to the invention, the distance determination process for individual imaging elements is carried out in a large-area, matrix, display.

The processor units may each be arranged in a hexagonal area, in which case each processor unit in each case has six adjacent processor units, which are each coupled to the processor unit via a bidirectional communication interface.

Furthermore, the pixels may themselves have a hexagonal shape.

The use of a hexagonal shape results in a very high packing density in the respective arrangement.

Alternatively, the processor units may each be arranged in a rectangular area, in which case each processor unit has four adjacent processor units, which are each coupled to the processor unit via a bidirectional communication interface.

Furthermore, pixels may themselves have a rectangular shape.

According to a further embodiment of the pixel arrangement, before determination of the distance between the pixel processors and the reference position, the local positions of the processor units within the processor arrangement are determined in that, on the basis of a processor unit at an introduction point of the processor arrangement, position determination messages (which have at least one row parameter z and one column parameter s which respectively contains the row number and the column number of the processor unit sending the message or the row number and the column number respectively, of the processor unit receiving the message within the processor arrangement) are transmitted to adjacent processor units, and the respective processor unit carries out the following steps:
if the row parameter in the received message is larger than the previously stored row number of the processor unit, then the processor unit's own row number is associated with the row parameter value z of the received message,
if the column parameter in the received message is greater than the processor unit's own column number, then the stored column number is associated with the row parameter value in the received message,
if its own row number and/or its own column number has been changed as a result of the method steps described above, then new position measurement messages with new row parameters and new column parameters are produced, which respectively contain the row number and the column number of the processor unit sending the message, or the row number and the column number of the processor unit receiving the message, and these are transmitted to a respective adjacent processor unit via the bidirectional communication interfaces.

This development of the pixel arrangement further extends the concept according to one embodiment of the invention of the local interchange of messages between mutually adjacent processor units since even the local positions of the individual processor units within the processor arrangement are, according to this concept, based on local position information, which is obtained only from the position information received from the immediately adjacent processor unit. This allows a procedure which is very robust with respect to faults for self-organization purposes for the processor arrangement.

According to another embodiment of the pixel arrangement, the processor unit's own distance value is changed using an iterative method when the previously stored distance value is greater than the received distance value increased by a predetermined value, in the respectively received message, and in the situation where a processor unit changes its own distance value, this processor unit produces a distance measurement message and sends it via all the communication interfaces to adjacent processor units, with the distance measurement message in each case containing its own distance as distance information, or the distance value which the receiving processor unit has from the portal processor.

The distance value can be changed by a value which is greater by a predetermined value than its own distance value, in one case by the value “1”.

The methods and arrangements described above are suitable, for example, for use in the following fields of application.

One embodiment of the invention provides for the processor units and, optionally and additionally, the pixels, that is to say the elements which produce and transmit an electromagnetic wave or the sensors, to be applied to textile material, and by means of electrically conductive couplings, which, for example, are woven into the textile material. Alternatively, the textile material may itself contain electrically conductive structures in order to electrically connect the processor units and/or the pixels to one another. The processor units and/or the pixels are in one case arranged at the intersections within the structure of the textile material, that is to say, for example, at the intersections of the electrically conductive warp and weft threads of a textile fabric.

In one embodiment of the invention, sound transmitters and sound sensors can be applied to the textile material as pixels, with a piece of clothing in one case being manufactured from the textile material. Using the sound transmitter and the sound sensors as pixels, it is possible to determine the position of the piece of clothing, and hence the position of a person who is wearing that piece of clothing in a room or in a building.

Furthermore, it is possible to use sensors integrated according to the invention in a piece of clothing for example to monitor the vital functions of someone who is wearing that piece of clothing.

In general, any desired sensors or actuators may be integrated as pixels in a textile material, and in one case in a piece of clothing.

In one alternative embodiment, the textile material is in the form of textile concrete, or expressed in other words is in the form of reinforcement in concrete.

A textile concrete designed in this way can thus be provided in a simple manner with, for example, pixels designed as pressure sensors and/or as vibration sensors and/or as tensile stress sensors, and/or as deformation sensors. A textile concrete according to one embodiment of the invention such as this may, in particular, be designed to be very flexible on the basis of the self-organizing method for position determination. In a building, the textile concrete may be used with the pixels and the processor units in order to detect possible danger situations in the building (excessive weight loading on a concrete ceiling), and to use the processors to transmit an appropriate warning message to a control computer which is electrically coupled to them via a building interface.

Alternatively, the textile concrete according to one embodiment of the invention may also be used for bridge construction. A bridge with a textile concrete such as this has, in particular, the advantage that it is now very easily possible to determine dangerous vibration or deformation of the bridge structure by means of the integrated pixel sensors, and to transmit an appropriate warning message to a control computer.

Another field of application for the textile concrete according to one embodiment of the invention is for road construction. A road which has the textile concrete can very easily be used for road usage (for example, the number of vehicles etc.) or else for traffic management control, and in general for traffic monitoring or even for speed control, since the pixel sensors which are integrated in the textile concrete can be used to determine the point and time at which a vehicle travels over the corresponding area of the road which is monitored, by a respective sensor.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a plan view of a pixel arrangement according to a first exemplary embodiment of the invention.

FIGS. 2a to 2d illustrate plan views and a section view of individual pixels which can be provided in the pixel arrangement, in which case the pixel may have a rectangular shape (FIG. 2a), a triangular shape (FIG. 2b) or a hexagonal shape (FIG. 2c); FIG. 2d illustrates a section view through the pixels illustrated in FIGS. 2a to 2c.

FIG. 3 illustrates a block diagram schematically illustrating the pixel arrangement with a drive device.

FIG. 4 illustrates a plan view of a processor arrangement according to the first exemplary embodiment of the invention.

FIG. 5 illustrates a plan view of a processor arrangement according to a second exemplary embodiment of the invention.

FIG. 6 illustrates a plan view of a processor unit with a hexagonal shape.

FIGS. 7a and 7b illustrate a directional graph (FIG. 7a) as well as a non-directional graph (FIG. 7b).

FIG. 8 illustrates a directional tree.

FIGS. 9a and 9b illustrate a sketch of a processor arrangement, modeled as a non-directional graph (FIG. 9a) and as a directional graph (FIG. 9b).

FIG. 10 illustrates a sketch of different routing paths as a directional tree with an input node as a root.

FIG. 11 illustrates a sketch of an optimized routing tree.

FIGS. 12a to 12j illustrate a sketch of the routing tree from FIG. 11 at different drive times.

FIGS. 13a to 13f illustrate a sketch of the routing tree from FIG. 11 at different drive times.

FIG. 14 illustrates a plan view of two hexagonal processor units, illustrating the bidirectional message interchange between the two processor units.

FIG. 15 illustrates a sketch of an incoherent processor unit.

FIG. 16 illustrates a sketch of a coherent processor unit with measurement coherence messages being transmitted.

FIG. 17 illustrates a sketch of a processor unit, on the basis of which the transmission of measurement position messages will be explained.

FIG. 18 illustrates a sketch of a processor arrangement after determination of the positions of the individual processor units within the processor arrangement.

FIG. 19 illustrates a sketch of a processor unit, on the basis of which the transmission of a measurement distance message will be explained.

FIG. 20 illustrates the processor arrangement after the distance determination process has been carried out with the processor arrangement having a large number of initial processor units at the lower edge of the processor arrangement.

FIG. 21 illustrates a processor arrangement after a distance determination process has been carried out, with every third processor unit in the lowermost row of the processor arrangement each having an associated reference position.

FIG. 22 illustrates a sketch of a processor unit, on the basis of which the reception and the transmission of measurement organize messages will be explained.

FIG. 23 illustrates a sketch of a processor unit, on the basis of which the organization sequence for transmission of a measurement channel message in an even-numbered column within the processor arrangement is illustrated.

FIG. 24 illustrates a sketch of a processor unit, on the basis of which the organization sequence for transmission of a measurement channel message in an odd-numbered column within the processor arrangement is illustrated.

FIG. 25 illustrates a sketch of a number of processor units, on the basis of which the organization and the message interchange via channels which couple the communication interfaces between the processor units to one another will be explained.

FIG. 26 illustrates a processor arrangement after regular backward organization has been carried out for the situation where information from or to a portal processor can be supplied or can be sent to all of the processor units in the lowermost row of the processor arrangement.

FIG. 27 illustrates a processor arrangement after regular backward organization has been carried out for the situation where information from or to a portal processor can be supplied or can be sent to every third processor unit in the lowermost row of the processor arrangement.

FIG. 28 illustrates a sketch of a processor unit, on the basis of which the reception and transmission of measurement count nodes messages will be explained.

FIG. 29 illustrates a sketch of a processor unit, on the basis of which the reception and the transmission of measurement node size messages will be explained.

FIG. 30 illustrates the processor arrangement once the throughput of the processor units has been determined, for the situation where information from or to a portal processor can be supplied or can be sent to all of the processor units in the lowermost row of the processor arrangement.

FIG. 31 illustrates the processor arrangement after the throughput of the processor units has been determined for the situation where information from or to a portal processor can be supplied or can be sent to every third processor unit in the lowermost row of the processor arrangement.

FIG. 32 illustrates a sketch of a processor unit, on the basis of which the transmission of measurement color distance messages will be explained.

FIG. 33 illustrates a sketch of a processor unit, on the basis of which the reception and the transmission of measurement block token messages will be explained.

FIG. 34 illustrates a sketch of a processor unit, on the basis of which the reception of a measurement token message by an “uncolored” processor unit is illustrated.

FIG. 35 illustrates the processor arrangement once meandering channels in the processor arrangement have been determined, with token allocation being carried out for the situation where information from or to a portal processor can be supplied or can be sent to all of the processor units in the lowermost row of the processor arrangement.

FIG. 36 illustrates a sketch of a processor unit, on the basis of which the reception and the transmission of measurement delete channel messages will be explained.

FIG. 37 illustrates a sketch of a processor unit, on the basis of which the reception and the transmission of measurement column organize messages will be explained.

FIG. 38 illustrates the processor arrangement after reorganization has been carried out for the situation where information from or to a portal processor can be supplied or can be sent to every third processor unit in the lowermost row of the processor arrangement.

FIG. 39 illustrates the processor arrangement after reorganization has been carried out for the situation where information from or to a portal processor can be supplied or can be sent to all of the processor units in the lowermost row of the processor arrangement.

FIG. 40 illustrates a sketch of a processor unit, on the basis of which the initialization of the initial processor unit color by means of a measurement color distance message will be explained.

FIG. 41 illustrates the processor arrangement after reorganization has been carried out for a weighting g=0 for the situation where information from or to a portal processor can be supplied or can be sent to all of the processor units in the lowermost row of the processor arrangement.

FIG. 42 illustrates the pixel arrangement after reorganization has been carried out for a weight of g=∞ for the situation where information from or to a portal processor can be supplied or can be sent to all of the processor units in the lowermost row of the processor arrangement.

FIG. 43 illustrates a sketch of a processor unit, on the basis of which the reception and the transmission of measurement numbering messages will be explained.

FIG. 44 illustrates a sketch of the processor arrangement after numbering has been carried out for the situation where information from or to a portal processor can be supplied or can be transmitted to all of the processor units in the lowermost row of the processor arrangement.

FIG. 45 illustrates the processor arrangement after numbering has been carried out for the situation where information from or to a portal processor can be supplied or can be transmitted to every third processor unit in the lowermost row of the processor arrangement.

FIG. 46 illustrates a routing table according to one exemplary embodiment of the invention.

FIG. 47 illustrates a sketch of a processor arrangement, on the basis of which the routing and the display of pixel data will be explained.

FIG. 48 illustrates a sketch of a processor unit, on the basis of which the reception and transmission of measurement retry messages will be explained.

FIG. 49 illustrates a sketch of a processor arrangement having a large number of processor units and a large number of pixels, with one group of pixels in each case being associated with one processor unit.

FIG. 50 illustrates a sketch of a 4×4 pixel group and of its drive by means of a processor unit.

FIG. 51 illustrates an overview of the messages that are used.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

FIG. 1 illustrates a pixel arrangement 100 according to a first exemplary embodiment of the invention.

The processor arrangement 100 is formed on the basis of a so-called “fluidic self assembly” (FSA) from the company Alien Technology™ as described in J. S. Smith, High-Density, low parasitic direct Integration by Fluidic Self-Assembly (FSA), IEDM, pages 201-204, 2000.

The processor arrangement 100 has a substrate 101 with a large number of depressions 102. The substrate 101 is, according to this exemplary embodiment, a thin, flexible plastic film with a large number of depressions stamped in it, via which a suspension having a large number of processor units 103, which are in the form of computer chips 103 and whose size is between 50 μm and 1000 μm, are floated in a liquid. The computer chips 103 are also referred to as nanoblocks. The size and shape of the integrated computer chips 103, which are referred to in the following text as processor units 103, corresponds to that of the depressions 102 so that the processor units 103 are automatically inserted into the depressions 102, that is to say organizing themselves.

This process is illustrated schematically in FIG. 1. This results in the manner described above in an array of processor units, which are then networked to one another, that is to say they are electrically coupled to one another.

The processor arrangement 100 is designed to form an image display device, in which the processor units are used to drive the pixels. For this purpose, an electro-optical medium (for example illuminated, reflective, etc.), an illuminating medium, is placed over the array formed by the processor units 103, to which electrical couplings are created, starting from the corresponding processor units 103 which control the electro-optical medium.

Each processor unit 103 is responsible for the pixel located directly above it, that is to say it drives this pixel, or for the pixel region located above it, that is to say a pixel area with a number of pixels which are grouped to form a pixel area.

The processor units 103 are for this reason also referred to in the following text as pixel processors 103.

In this context, it should be noted that the invention is in no way restricted to imaging elements as the processor arrangement or pixel arrangement, but can likewise be used for a sensor array with a large number of sensors which are electrically coupled to one another and are driven via in each case one or more processor units 103.

According to one embodiment of the invention, arrays may also be used which partially contain imaging elements and partially contain sensor elements.

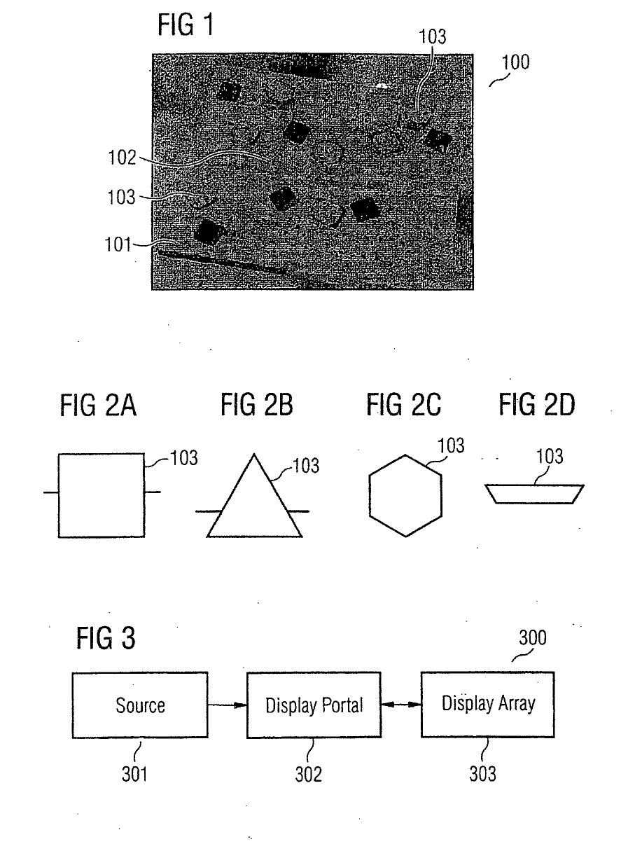

The individual processor units 103 may, according to one embodiment of the invention, have any desired shapes, for example being rectangular as illustrated in FIG. 2a, triangular as illustrated in FIG. 2b or hexagonal as illustrated in FIG. 2c.

FIG. 2d illustrates a trapezoidal cross section through the respective processor units 103. The trapezoidal cross section ensures that the individual pixels are self-organizing inserted into the depressions 102 in the pixel arrangement more easily and with a greater probability.

A pixel arrangement which is in the form of an imaging system, that is to say in other words an image producing system, will be described in the following text, without any restriction to generality.

The imaging system 300 according to one exemplary embodiment of the invention is illustrated schematically in the form of a block diagram in FIG. 3.

The imaging system 300 has a source 301 which represents the source of the information to be displayed and, according to this exemplary embodiment, contains a central processing unit (CPU), a graphics processor, sensors or other input appliances and, optionally, further components.

Furthermore, a display unit portal 302 is provided, which is electrically coupled to the source 301 and represents the function of an average between the source 301 and the actual pixel arrangement 303, which is likewise coupled to the display unit portal 302 (and which comprises the processor arrangement and the pixels). The display unit portal 302 is, according to one embodiment of the invention, used to generate a trigger, that is to say an initiation signal, according to this exemplary embodiment, an initiation message, for initialization of the self-organization, as well as for information distribution via initial processor units in the processor arrangement 303.

The processor arrangement 303 has an array of uniform, so-called intelligent pixels or pixel regions, which are formed by processor units 103 and by the pixels which are coupled to the processor units 103 and are driven by the processor units 103. The processor units 103 are networked to one another, that is to say they are coupled to one another via bidirectional communication interfaces which are associated with each of the processor units 103.

Some of the processor units 103 from the large number of processor units 103 in the pixel arrangement 303 are used as initial nodes for supplying information from the display unit portal 302 to the processor arrangement 100 for the pixel arrangement 303.

According to this exemplary embodiment, none of the processors—referred to as portal processors in the following text—of the display unit portal 302, has any information whatsoever about the size and configuration of the pixel arrangement 303. In addition, at the start of the method, none of the individual processor units 103 or the pixels which are coupled to the processor units 103 have any information whatsoever about their respective orientation, that is to say alignment, or their local position within the processor arrangement.

In addition, none of the individual pixel processors, that is to say the processor units, has any information whatsoever about its own alignment and position, that is to say its local position within the processor arrangement.

In an initialization phase, which will be explained in detail in the following text (before the first use of the pixel arrangement 303 or after stored information in the pixel arrangement 303 has been reset), the portal processor for the display unit portal 302 initiates self-organization of the processor arrangement, as will be explained in more detail in the following text.

In the course of the self-organization of the processor arrangement, the processor units 103 in the pixel arrangement 303 learn their position and alignment as well as information paths to the image construction, that is to say for supplying image information to be displayed to the respective pixels which are actually intended to display the respective image information.

This learning process is carried out using messages which are interchanged between respectively mutually adjacent processor units in the pixel arrangement 303. Part of the knowledge that has been learned is passed to the exterior again, that is to say to the display unit portal 302, to be precise, to the extent that the display unit portal 302 will require it later in order to supply the image information on the correct paths and in the correct sequence to the pixel arrangement 303 for display of a respective image to be displayed.

The nature of the image information must be taken into account for image construction, that is to say for the procedure for the information distribution of image information to be displayed within the pixel arrangement 303.

According to these exemplary embodiments, individual pixel data for display of a complete image or of a difference image, for example, for compressed video images, is transmitted to the individual pixels, that is to say to be more precise to the individual pixel processors 103. For this purpose, each pixel processor 103 is individually addressed by the portal processor in the display unit portal 302. This leads to routing of the image information (as required in order to display image information) to the corresponding pixels and thus to the corresponding processor units within the pixel arrangement. According to one embodiment of the invention, the following special features of the routing problem must be taken into account for the routing of individual pixel data:
Routing paths are defined only between the portal processor for the display unit portal 302 and the individual pixel processors, that is to say the processor units in the pixel arrangement 303, but not between the pixel processors themselves.
The rate at which routing requirements occur is uniform, that is to say one and only one pixel data item need be transmitted to each pixel processor for each digitized image to be displayed.
No global knowledge is assumed about the shape of the network, that is to say the networking of the individual pixel processors within the processor arrangement. The choice of routing paths within the processor arrangement is made on the basis of local information, which is interchanged between the individual pixel processors using electronic messages.

It is thus possible, according to the invention, to distinguish between two phases with regard to the use of a pixel arrangement according to one embodiment of the invention:

In a first phase, the so-called self-organization, the following items are carried out:
self-identification of the local positions of the individual pixel processors within the pixel arrangement, and thus of the overall shape of the pixel arrangement;
self-organization of routing paths starting from the portal processor, that is to say the processor for the display unit portal 302, to each pixel processor in the pixel arrangement 303 such that each pixel processor can be supplied with an electronic message from the processor for the display unit portal 302 within a predetermined maximum number of clock cycles.

In a second phase, the actual use of the pixel arrangement 303 for displaying image data, the image data is sent from the portal processor to the pixel processors, that is to say it is transmitted, by which means the image to be displayed is formed in the pixel arrangement 303.

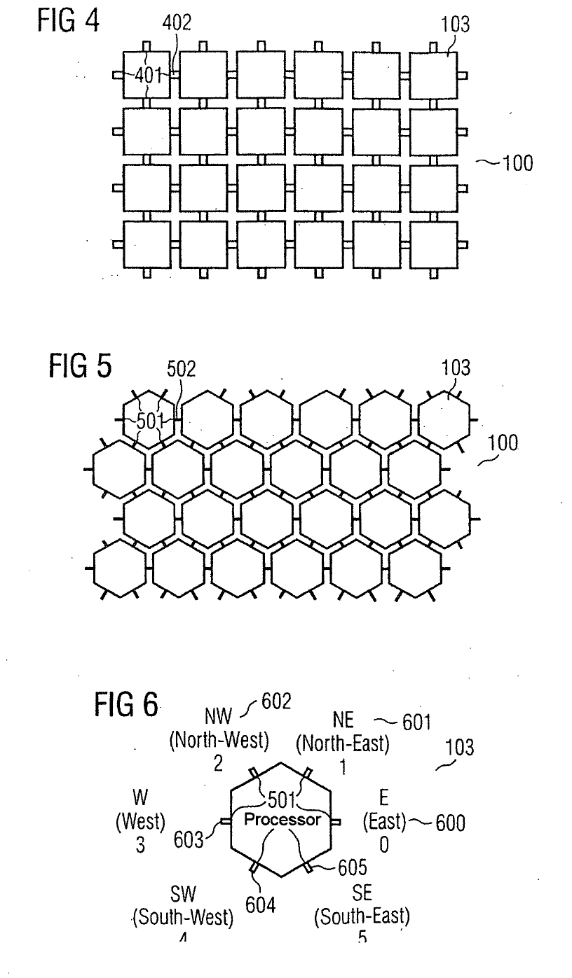

In the situation where the pixel processors 103 have a rectangular shape, a square shape, they are, as is illustrated in FIG. 4, in each case coupled by each side of the quadrilateral via one of the bidirectional communication interfaces 401 (of which four are in each case therefore provided) for each pixel processor 103 and, furthermore, via electrical lines 402 to the respective pixel processor 103 which is immediately adjacent to any given pixel processor 103.

In other words, this means that this in each case makes it possible to interchange messages between two directly mutually adjacent pixel processors, but does not allow direct message interchange over a longer distance than the direct proximity of a pixel processor 103.

FIG. 5 illustrates another exemplary embodiment, in which each pixel processor 103 has a hexagonal shape and six bidirectional communication interfaces 501 are provided, likewise on each side, that is to say side edge, of the respective pixel processor 103 for each pixel processor 103. This means that, according to this exemplary embodiment, each pixel processor 103 has six adjacent pixel processors 103, to which the respective pixel processor 103 is coupled via a bidirectional communication interface 501 and an electrical line 502 for interchanging electronic messages.

In order to describe the invention in a simpler form, the following text describes only the situation for the hexagonal shape of a pixel processor 103, without any restriction to general applicability.

The pixel arrangement 100 thus has two types of individual component:
pixel processors 103 which each have up to six bidirectional communication interfaces 501 and electrical lines 502, and
bidirectional connections, also referred to in the following text as a bidirectional communication interface 501 and the electronic line 502 which is associated with the respective communication interface 501, and which couple, in each case two pixel processors 103 or one pixel processor 103 and the portal processor, to one another.

The hexagonal pixel processor 103 may have six different alignments, as is illustrated in FIG. 6.

As is illustrated in FIG. 6, the individual connections, that is to say therefore, the individual communication interfaces 101 as well, have already been oriented during the self-organization phase, as will be explained in more detail in the following text. The connections are, according to this exemplary embodiment, numbered successively and, in order to assist understanding, are identified by compass directions, with the following nomenclature being used for this exemplary embodiment:
a first alignment 0 (east) (reference symbol 600), in other words an alignment to the right,
a second alignment 1 (north-east) (reference symbol 601), in other words alignment upwards and to the right,
a third alignment 2 (north-west) (reference symbol 602), in other words alignment to the left and upwards,
a fourth alignment 3 (west) (reference symbol 603), in other words alignment to the left,
a fifth alignment 4 (south-west) (reference symbol 604), in other words alignment to the left and downwards, as well as
a sixth alignment 5 (south-east) (reference symbol 605), in other words alignment to the right and downwards.

This exemplary embodiment is based on the assumption that the portal processor for the display unit portal 302 has electrical couplings for pixel processors 103 on only one side of the pixel arrangement 100.

By definition, this is assumed to be the lower side of the pixel arrangement 100, that is to say obviously the south side, with the couplings, likewise by definition, running over the south-west side that is to say over the fifth alignment direction of the respective pixel processors 103.

In this context, it should be noted that both the positioning and the alignment of the individual points at which information is introduced to the pixel processors 103 in the processor arrangement 100 and the shape and alignment of the individual pixel processors 103 in the processor arrangement 100 are in principle undefined.

In different embodiments of the invention, the portal processor
is electrically coupled to all of the pixel processors 103 which are arranged in the form of a matrix in the lowermost row, that is to say in rows and columns, in the processor arrangement 100 or,
is electrically coupled to pixel processors 103 in the lowermost row of the processor arrangement at a predetermined regular, that is to say periodic, distance apart, that is to say every third, fifth, tenth, etc. pixel processor 103 within the lowermost row in the processor arrangement.

Once the pixel arrangement 303 has been completed, the portal processor admittedly knows the number of its connections to the pixel processors 103, or in other words the number of introduction points for supplying information to pixel processors 103 within the pixel arrangement 303, but does not necessarily know the dimension and the configuration of the pixel arrangement 303, and hence of the processor arrangement, that is to say the actual shape and arrangement of the pixel processors 103 within the processor arrangement 100.

In this context, it should be noted that, in particular, a direction statement, for example the south side, need not necessarily represent a straight line within the processor arrangement 100.

In the case of method elements which will be explained in the following text, the only provision is that the individual connections between the portal processor and the pixel processors 103 should always be made at the same point, according to this exemplary embodiment and via the south-west side 604.

The individual pixel processors 103 or the connections which are both referred to as a generic term for individual components of the processor arrangement, may assume the following states:

1. Fault-Free:

The respective component in the pixel arrangement is operating without any restrictions.

2. Defective:

The respective component in the pixel arrangement has failed completely. If the component is a processor unit, then all of the connections to this processor unit must likewise be declared as defective.

3. Unstable:

The component has partial failures, for example, one direction of a bidirectional connection between the respective processor unit operates only at times (that is to say it has an intermittent contact or is operating methodically incorrectly, for example, a processor which sends an incorrect message).

In order to simplify the description of the invention, the third state is not considered in the following text, that is to say a component is in the following text assumed to be either fault-free or defective. For these exemplary embodiments it is therefore irrelevant whether a component does not exist owing to a specific form of the pixel arrangement (that is to say, for example, a display unit foil which is in the form of a triangle), or whether the respective component has become defective owing to a manufacturing fault or owing to wear having taken place.

The following text considers the clocking of the overall system, that is to say of the entire pixel arrangement 303, when information is passed on as will be explained in more detail in the following text, that is to say when electronic messages are sent between two pixel processors 103 within the pixel arrangement 303, or from the portal processor to a pixel processor 103 at an introduction point to the pixel arrangement 303.

Each pixel processor 103 in the pixel arrangement 303 is designed such that it can carry out the following actions within one clock cycle:
Reading of one or more electronic messages which are present on one or more connections, that is to say via one or more bidirectional communication interfaces of the respective pixel processor, and which were sent in the previous clock cycle from an adjacent pixel processor.
Processing of the received message.
If appropriate, sending of one or more messages via one or more connections and thus via one or more bidirectional communication interfaces of the pixel processor 103, which can be received in the subsequent clock cycle, that is to say the next clock cycle by an adjacent pixel processor.

Within one clock cycle, an electronic message can therefore be transmitted only from one pixel processor 103 to an adjacent pixel processor 103.

However, in this context, it should be noted that, according to the invention there need not be a global common clock for the pixel processors 103 throughout the entire processor arrangement 100, although this is assumed in the following text in order to simplify the description of the invention.

In order to make it easy to understand the procedure according to the invention, the following text explains the principles relating to mathematical modeling of the pixel arrangement.

In the following text, the pixel processors 103 and the display unit portal 302 are modeled jointly as a directional graph as well as routing paths as a directional tree.

The choice of routing thus becomes a discrete optimization problem.

Definition 1 (Directional Graph, Non-Directional Graph)

(i)

based on the assumption of a set V and a set E, then: if
g:E→V²=V×V
is a map with the components
g⁻:E→V and g⁺:E→V,
that is to say
g:E→V²,
g:E→V²,
e→(g⁻(e),g⁺(e)),
so that the tuple is:
(V,E,g)
directional graph with the corner set (node set) V, edge set E and incidence map g. g⁻(e) is called the initial corner of the edge e ε E and g⁺(e) is called the terminating corner of the edge e ε E.

(ii)

Let us assume a set V and a set M. The following equivalence relationship is considered:
α:={((x, y), (y, x))εV²×V²; with x, y ε V}⊂V²×V²
with the equivalence classes
[x, y]:={(x, y), (y, x)}, for all x, y ε V.
With a map
u:M→V²/α={[x,y];x,y ε V}
the tuple is
(V, M, u)
non-directional graph with corner set (node set) V, edge set M and incidence map u.

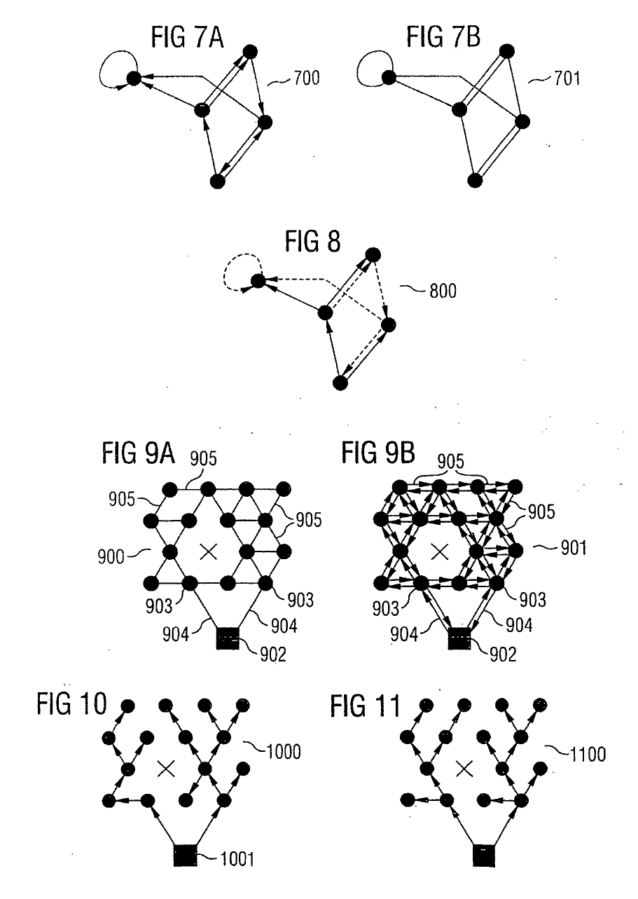

FIG. 7a illustrates a directional graph 700, and FIG. 7b illustrates a non-directional graph 701.

Definition 2 (Terminated Edges, Initiated Edges)

Let us assume that (V, E, g) is a directional graph and that v ε V. Then let us assume that Eₜₑᵣₘ(v) is the set of the edges terminated by v, that is to say
Eₜₑᵣₘ(v):={e ε E; g⁺(e)=v},
and that Eᵢₙᵢₜ(v) is the set of the edges initiated by v, that is to say
Eᵢₙᵢₜ(v):={e ε E;g⁻(e)=v};
Definition 3 (Path in a Directional Graph)

Let us assume that (V, E, g) is a directional graph K⊂E.

(i)

For a, b, ε V and n ε N we define

$${Γ}_{K}^{n} ( a , b ) := \{ \begin{matrix} ( {k}_{1} , … , {k}_{n} ) ∈ {K}^{n} ; a = {g}^{-} ( {k}_{1} ) {g}^{+} ( {k}_{n} ) = b \\ {g}^{+} ( {k}_{i} ) = {g}^{-} ( {k}_{i + 1} ) for i = 1 , … , n - 1 , \\ \vert \{ a , {g}^{+} ( {k}_{1} ) , … , {g}^{+} ( {k}_{n} ) \} \vert = n + 1\end{matrix} \}$$

as the set of all the paths from a to b of length n with edges K (Γ_{K}ⁿ(a,b)={ }, if no such path exists).

(ii)

For a, b ε V we define

$${Γ}_{K} ( a , b ) := {⋃}_{n ∈ N} {Γ}_{K}^{n} ( a , b )$$

as the set of all paths from a to b with edges from K.
Definition 4 (Directional Tree)

Let us assume that (V, E, g) is a directional graph V≠0. (V, E, g) is called the directional tree, if there is one w ε V such that
|Γ_{E}(w, v)|=1, for all v ε V\{w}
and for all K⊂E,K≠E
|Γ_{K}(w, v)|=0, for at least one v ε V\<w>.

This means that there is one and only one path from w to each corner v≠w, and the edge set cannot be reduced in size. The unique corner w is called the root of the directional tree.

The second condition in the above Definition 4 guarantees the uniqueness of the root, which would otherwise not exist, and prevents the existence of superfluous edges in the tree.

FIG. 8 illustrates an example of a directional tree 800 as a part of the directional graph sketched in FIG. 7a.

Lemma 5 (Characteristics of a Directional Tree)

Let us assume that (V, E, g) is a directional tree. Then for all a, b ε V
|Γ_{E}(a, b)|+|Γ_{E}(b, a)|≦1.
Definition 6 (Path Length, Throughput)

Let us assume that (V, E, g) is a directional tree with root w ε V. We define

(i)

for each v ε V\{w}, let us assume γ_{E}(v)ε Γ_{E}(w, v) is the only path from w to v, that is to say
γ_{E}(w, v)={γ_{E}(v)}.

(ii)

for each v ε V\{w}, there is one n ε N, where
{γ_{E}(v)}=Γ_{E}(w, v)=Γ_{E}ⁿ(w, v).

We define |γ_{E(v)}|:=n as the path length of the path γ_{E(v)}.

(iii)

We define |V|<∞ and all v ε V
d_{E}(v):=1+|{z ε V; Γ_{E}(v, z)≠{ }}|ε N
as the throughput of the node v.
Definition 7 (Branch)

Let us assume that (V, E, g) is a directional tree. We define for all v ε V
V_{E}(v):={v}∪{z ε V; Γ_{E}(v, z)≠{ }}
as a branch of the node v.

The Lemma is as follows:

Lemma 8 (Power of the Branch)

Let us assume that (V, E, g) is a directional tree and that v ε V. Then:
d_{E}(v)=|V_{E}(v)|.

The overall network of the imaging system 300, including the portal processor, is described in the following text in the form of a graph. In order to model the fact that existing connections between two nodes always have continuity in two directions, which symbolizes bidirectional communication, a non-directional graph will be considered first of all. An equivalent directional graph will then be derived, in order to define the routing.

Definition 9 (Display Graph)

Let us assume that (V, M, u) is a non-directional graph with

(i)
2≦|V|<∞,1≦|M|<∞,

(ii)

u injective (that is to say no two corners)

(iii)
u(E)∩{[x, x]; x ε V}={ } (that is to say without any loops)

(iv)

Let us assume that w ε V is an excellent node and is called a portal (node).

Let us assume that (V, E, g) is the directional graph for which: for each m ε M let us consider new elements m⁻ and m⁺ such that
E:={m⁻; m ε M}∪{m⁺; m ε M}; |E|=2|M|.

The map g is chosen such that
u(m)={g(m⁻), g(m⁺)}, for all m ε M.

In addition

(v)
Γ_{E}(w, v)≠{ } for all v ε V\{w} (that is to say, cohesively),
then (V, E, g) is called a display unit graph, which is also referred to in the following text as a display graph.

A corresponding non-directional graph 900 (see FIG. 9a) and the directional pixel arrangement graph 901 which is equivalent to it (FIG. 9b) are illustrated in the form of examples in FIG. 9a and FIG. 9b.

On the basis of this exemplary embodiment, a hexagonal 4×4 pixel array with a defect is selected. The above Definition 9 is generally satisfied. The networks under consideration have further restrictive characteristics, although these will be mentioned only briefly here, initially.
With the exception of the portal node 902, the number of edges with which a node 903 may be associated as an initial (terminating) corner is limited by a number q ε N. Until now q=4 (orthogonal network) and q=6 (hexagonal network) have been considered.
The directional graph 901 is in general a planar graph or a graph which can be flattened (extensions are feasible in which this is true only for the sub-graph which does not contain the portal node 902, if the supply lines 904 are not fed in at the edge of the pixel arrangement 100).

For the rest of the explanation, it is worthwhile considering not only the portal node 902 but also those nodes 903 which have a direct connection to the portal node 902. As described above, these nodes are referred to as initial nodes 903, that is to say they represent the reference positions with which the initial pixel processors in the pixel arrangement are associated. The edges from the portal node 902 to the initial nodes 903 are referred to in the following text as supply lines 904 and the edges 905 between pixel processors are referred to as network connections.

Definition 10 (Supply Lines, Network Connections, Initial Nodes)

Let us assume that (V, E, g) is a display graph with portal nodes w. The set of supply lines is then defined by
Eₚₒᵣₜ:={e ε E; g⁻(e)=w}
and the set of network connections by
Eₙₑₜ:={e ε E; g⁻(e)≠w\hat{ } g⁺(e)≠w}.

The set of initial nodes is defined by
Vₚₒᵣₜ:=g⁺(Eₚₒᵣₜ).

The problem which results when an electronic message is intended to be transmitted to each node in a pixel arrangement graph from the portal node within one time frame (within a refresh rate) will be considered in the following text.

If this is done, as is obvious from this description, of fixed chosen paths and if paths which have separated do not cross again, then this means that a directional tree should be chosen as the sub-graph of the pixel arrangement graph. This directional graph, which is also referred to as a routing tree, then defines the paths for the information flow uniquely, but not the dynamics of the information flow.

The routing tree is not unique; in general, the set of all possible trees is incomprehensibly large.

Definition 11 (Permissible Tree Set, Permissible Edge Set)

Let us assume that (V, E, g) is a display graph with portal nodes w ε V. The set of all permissible directional trees in (V, E, g) is defined as
B:={(V K, g |_{K}); where K⊂E and (V, K, g|_{K}) is a directional tree with the root w}.

The set of all permissible edge sets relating to (V, E, g) is then defined as
κ:={K⊂E; (V, K, g|_{K})ε B}.

One example of a permissible tree 1000 is illustrated in FIG. 10, with the corresponding routing paths with the portal node 1001 as the root node of the directional tree 1000.

The following expressions are introduced on the basis of Definition 10:

Definition 12 (Supply Lines, Network Connections)

Let us assume that (V, E, g) is a display graph with portal nodes w and that K ε κ. The set of supply lines in K is then defined by
Kₚₒᵣₜ:=Eₚₒᵣₜ∩K.

The set of network connections is defined by
Kₙₑₜ:=Eₙₑₜ∩K.

A number of criteria are described in the following text for assessment of trees:

Definition 13 (Tree Assessments)

Let us assume that (V, E, g) is a display graph with portal nodes w ε V and the set κ are permissible edge sets.

(i)

For all v ε V\{w} then

$${I}_{min} ( v ) := {min}_{k ∈ κ} \{ \vert {γ}_{K} ( v ) \vert \}$$

defines the distance between the node v and the root w in the display graph.

(ii)

For all K ε K

$$L ( K ) := {max}_{v ∈ V \backslash \{ w \}} \{ \vert {γ}_{K} ( v ) \vert \}$$

defines the maximum distance in the tee (V, K, g|_{K}) defined by K.

$${L}_{min} := {min}_{K ∈ κ} \{ L ( k ) \}$$

is then the maximum distance in the display graph.

(iii)

For all K ε κ

$$D ( K ) := {max}_{v ∈ V \backslash \{ w \}} \{ {d}_{k} ( v ) \}$$

defines the maximum throughput in the tree (V, K, g|_{K}) defined by K.

$${D}_{min} := {min}_{K ∈ κ} \{ D ( K ) \}$$

is then the maximum throughput in the display graph.

At least the following problems may be considered in order to select the “best” trees or edge sets:

(i)

The set of trees whose nodes each have the shortest distance to the root:
Oᵢ:={K ε κ; |γ_{K}(v)|=lₘᵢₙ(v) for all v ε V\{w}},

(ii)

Set of trees whose maximum separation is a minimum:
O₂:={K ε κ; L(K)=Lₘᵢₙ},

(iii)

Set of trees whose maximum throughput is a minimum:
O₃:={K ε κ; D(K)=Dₘᵢₙ}.

As can easily be seen O₁⊂O₂.

If O₂∩O₃≠{ }, all the trees from O₂∩O₃ minimize the functions L and K, and are particularly suitable as a routing tree.

If O₂∩O₃≠{ } is not true, then relaxed problem descriptions are necessary.

(iv)

Set of trees whose maximum separation is at the most a ε N₀ greater than the minimum:
O₄^{a}:={K ε κ; L(K)≦Lₘᵢₙ+a}

(v)

Set of trees whose maximum throughout is at the most b ε N₀ greater than the minimum:
O₅^{b}:={K ε κ; D(K)≦Dₘᵢₙ+b}.

For a suitable choice of a, b ε N₀
O₄^{a}∩O₅^{b}≠{ }is always possible.

However, the problem can also be described as a multi-criteria combinational optimization problem with two target functions.

For the display unit graph illustrated in FIG. 9b, the routing tree 1000 as illustrated in FIG. 10 is undoubtedly not optimum, to be precise it is not based on any of the above criteria. The tree 1100 illustrated in FIG. 11 in contrast, is intersected by O₃ even at O₁.

The above text has explained how the paths of the information flow can be defined in the display unit network by the choice of a routing tree from a permissible tree set. In order to supply the display unit nodes with the information that is required for image construction, the portal node transmits an electronic message along these paths to each node. Parallel transmission of all the electronic messages is generally not possible, since certain capacities, such as how many messages can be transmitted via one edge in one clock cycle and how many messages can be buffer-stored in a node (queue) must not be exceeded. The timing (dynamics) for the information flow should thus be determined.

In the following text (V, E, g) is assumed to be a display unit graph with the portal nodes w. Let us assume that r:=|V|−1 and V={v₀, v₁, . . . vᵣ}, v₀=w. On the further assumption that K ε κ then certain “overall” routing matrices τ and, subsequently, certain “individual” routing matrices σ¹, 1=1, . . . , r, can be introduced.

τ contains the information as to how many electronic messages are to be transmitted via the individual edges from K in the individual clock cycles. In this case, conditions at τ are formulated such that the capacities are complied with and there is one electronic message in each node at the end. No distinction in τ is yet drawn between different messages (that is to say the individual pixel data items). It is not yet directly evident from τ how routing of a specific individual pixel data item through the respective target pixel takes place or can take place. However, it is possible to derive from r certain “individual” routing matrices σ¹, 1=1, . . . , r, which precisely describe this routing of the individual pixel data items to the target pixels v₁, 1=1, . . . r. The “individual” routing matrices σ¹, 1=1, . . . r, are in this case not necessarily unique, although the assessment of the routing on the basis of the routing duration depends essentially only on τ. The following text therefore considers routing as being already given by τ.

Definition 14 (Routing Map, Routing Matrix)

Let us assume that K={k₁, . . . ,kᵣ} ε κ (but note that |K|=|V|−1). cₚₒᵣₜ, cₙₑₜ, q ε N is assumed. A (cₚₒᵣₜ, cₙₑₜ, q) routing map or matrix through the tree (V,K,g|_{K}) which is defined by K is a matrix
τ=(τᵢⱼ)i=1, . . . , n ε N₀^{n,r}, n ε N,
j=1, . . . , r
with the following characteristics

(i)

$${τ}_{ij} \leq {c}_{port} for all j ∈ \{ 1 , … , r \} where {k}_{j} ∈ {K}_{port} and all$$

$$i ∈ \{ 1 , … , n \} , as well as {τ}_{ij} \leq {c}_{net} for all j ∈ \{ 1 , … , r \}$$

$$where {k}_{j} ∈ {K}_{net} and all i ∈ \{ 1 , … , n \} ,$$

(ii)

for all v ε V\{w} and 1≦m≦n then

$${\sum }_{1 \leq i \leq m - 1} {{\sum }_{1 \leq j \leq r ,}}_{{k}_{j} ∈ {K}_{term} ( v )} {τ}_{ij} - {\sum }_{1 \leq i \leq m} {{\sum }_{1 \leq j \leq r ,}}_{{k}_{j} ∈ {K}_{init} ( v )} {τ}_{ij} \geq 0 ,$$

(iii)

for all v ε V\{w} and 1≦m≦n then

$${\sum }_{1 \leq i \leq m} {{\sum }_{1 \leq j \leq r ,}}_{{k}_{j} ∈ {K}_{term} ( v )} {τ}_{ij} - {\sum }_{1 \leq i \leq m} {{\sum }_{1 \leq j \leq r ,}}_{{k}_{j} ∈ {K}_{init} ( v )} {τ}_{ij} \leq q ,$$

(iv)

for all v ε V\{w} then

$${\sum }_{1 \leq i \leq n} {{\sum }_{1 \leq j \leq r ,}}_{{k}_{j} ∈ {K}_{term ( v )}} {τ}_{ij} - {\sum }_{1 \leq i \leq n} {{\sum }_{1 \leq j \leq r ,}}_{{k}_{j} ∈ {K}_{init ( v )}} {τ}_{ij} = 1.$$

cₚₒᵣₜ is called the capacity of the supply lines, cₙₑₜ is called the capacity of the network connections and q is called the maximum queue length.
|τ|:=n
is called the routing duration. The set of all (cₚₒᵣₜ, cₙₑₜ, q) routing matrices over (V,K,g|_{K}) is referred to as [symbol]
_{c}_{_{port,}}_{c}_{ₙₑₜ},_{q}(K).

The extension in comparison to the already considered routing trees is primarily that τ also contains a time component.

The matrix entry τᵢⱼ, i ε {1, . . . n} j ε {1, . . . r} states that τᵢⱼ messages are transmitted via the edge kⱼ in the ith clock cycle.

Condition (i) ensures compliance with predetermined supply line capacities and network capacities.

Condition (ii) ensures the necessary causality in the network. Messages can be passed on from a node only when they have previously been transmitted to this node (that is to say at least one clock cycle prior to this).

Condition (iii) takes account of the memory space restrictions in the nodes.

Finally, according to the condition (iv) there is one and only one message in the node after n time units.

Together with the routing tree, the routing matrix thus indicates a routing method with details of the timing of the individual steps, and which supplies the network with messages at the same time.

The following is defined:

Definition 15 (Routing)

Let us assume that cₚₒᵣₜ, cₙₑₜ, q ε N. A (cₚₒᵣₜ, cₙₑₜ, q) routing is a tuple (K, τ) comprising a permissible edge length k={k₁, . . . kᵣ} ε κ and a routing matrix τ ε Rcₚₒᵣₜ,cₙₑₜ,q(K). The set of all the routings is referred to as Rcₚₒᵣₜ,c_{net,q}.

We will now see in the following text how the dynamic routing is produced for each individual node.

For this purpose, matrices σ¹ ε {0,1}^{n,r}, 1=1, . . . , r, are determined on the basis of the following algorithm:

```
τ⁰ := τ;
for 1 = 1,...,r:
{
  σ¹ := 0^{n,r} ∈ {0,1}^{n,r};
  assuming (k_{P1}, . . . , k_{Pz}), z ∈ N, the path from w to v₁;
  i_{z+1} :=n + 1;
  for y :=z,...,1, in decreasing order:
{
```

i_{y} := max{i ∈ {1,...,i_{y+1} − 1}: τ_{i,p}_{_{y}}^{l-1} > 0};
σ^{l}ᵢ_{y}p_{y} := 1 ;
}
τ^{l} := τ^{l-1} − σ^{l} ;

}

It can easily be shown that the algorithm is well-defined and that τ^{r}=0^{n,r}. In consequence

$${\sum }_{1 \leq l \leq r} {σ}^{l} = τ . \\ and$$

$${\sum }_{1 \leq i \leq n} {{\sum }_{1 \leq j \leq r ,}}_{{k}_{j} ∈ {K}_{term ( {v}_{\tilde{l}} )}} {σ}_{ij}^{l} - {\sum }_{1 \leq i \leq n} {{\sum }_{1 \leq j \leq r ,}}_{{k}_{j} ∈ {K}_{init ( {v}_{\tilde{l}} )}} {σ}_{ij}^{l} = {δ}_{l \tilde{l}} .$$

for all l,\overline{l} ε {1, . . . , r}. A matrix entry σᵢⱼ^{l}=1 states that the message is passed on to v₁ in the ith clock cycle via the edge kⱼ.

Two lemmata are stated as an evidential sketch to show that the algorithm is well-defined.

Lemma 16 (to Show that a is Well-Defined)

Let us assume that 1 ε {1, . . . , r}. If τ^{l-1}ε N₀^{n,r} satisfies the condition (ii) from the Definition 14 for all v ε V\{w} and the condition (iv) from the Definition 14 for v:=eₗ, then σ¹ can be chosen on the basis of the algorithm.

Lemma 17 (Characteristics of τ¹)

Let us assume that lε {1, . . . , r}. If τ^{l-1}ε N₀^{n,r} satisfies the preconditions of Lemma 16 and if σ¹ is chosen on the basis of the above algorithm, then τ¹ also satisfies the preconditions of Lemma 16.

Definition 18 (Routing Matrix to the Individual Nodes)

Let us assume that cₚₒᵣₜ, cₙₑₜ, q ε N. (K, τ) ε R_{c}_{ₚₒᵣₜ},_{c}_{_{net,q}} is assumed, and the matrices σ¹, 1=1, . . . , r, are assumed to have been chosen on the basis of the above algorithm. The σ1, 1=1, . . . , r routing matrices to the nodes are then v₁, 1=1, . . . r with respect to (K, τ).

The matrices τ and σ¹, 1=1, . . . , r are often constructed in the reverse manner. We define matrices σ¹, 1=1, . . . , r by stating the timing sequence in which the message is passed to v₁ via the path γ_{K}(v₁). τ is then given by

$$τ := {\sum }_{1 \leq l \leq r} {σ}^{l} .$$

The time sequence for the routing to each individual node and thus the σ¹, 1=1, . . . , r must in this case be chosen such that the capacities of edges and nodes are not exceeded, that is to say T satisfies the items (i) and (iii) from the Definition 14.

Criteria relating to a “good” and if possible “optimum” choice of routing methods in a display unit graph are quoted in the following text. In the following text, routing is regarded as being optimum when it corresponds to the shortest possible duration. In order to be able to record this in mathematical language, the following expressions are introduced.

In this case let us assume that (V, E, g) is always a display unit graph and, as before, V={v₀, . . . Vᵣ) where v₀=w.

Definition 19 (Minimum Routing Duration)

(i)

Let us assume that K={k₁, . . . ,kᵣ} ε κ and that cₚₒᵣₜ, cₙₑₜ, q ε N. Then

$${T}_{{c}_{port} , {c}_{net} , q}^{min} ( K ) := {min}_{τ ∈ {R}_{{c}_{port} , {c}_{net} , q} ( K )} \{ \vert τ \vert \}$$

defines the minimum routing duration through the tree (V,K,g|_{K}) which is defined by K.

(ii)

Let us assume that cₚₒᵣₜ, cₙₑₜ, q ε N. Then

$${T}_{{c}_{port} , {c}_{net} , q}^{min} := {min}_{K ∈ κ} \{ {T}_{{c}_{port} , {c}_{net} , q} ( K ) \}$$

defines the minimum routing duration in the display graph.
Definition 20 (Optimum Routing)

(i)

Let us assume that k={k₁, . . . ,kᵣ} ε κ and that cₚₒᵣₜ, cₙₑₜ, q ε N. The expression optimum routing matrix in the tree defined by (V,K,g|_{K}) is understood to be a routing matrix from the following set:

$${R}_{{c}_{port} , {c}_{net} , q}^{min} ( K ) := \{ τ ∈ {R}_{{c}_{port} , {c}_{net} , q} ( K ) ; \vert τ \vert = {T}_{{c}_{port} , {c}_{net} , q}^{min} ( K ) \} .$$

(ii)

Let us assume that cₚₒᵣₜ, cₙₑₜ, q ε N. The expression optimum routing means a routing from the following set:

$${R}_{{c}_{port} , {c}_{net} , q}^{min} := \{ \begin{matrix}( K , τ ) ; K = \{ {k}_{1} , … , {k}_{r} \} ∈ κ , τ ∈ {R}_{{c}_{port} , {c}_{net} , q} ( K ) \\ und \vert τ \vert = {T}_{{c}_{port} , {c}_{net} , q}^{min}\end{matrix} \}$$

The choice of an optimum routing matrix in the already defined routing tree in the sense of definition 20 (i) is simple. This is explained in the present section for the special cases cₚₒᵣₜ and cₙₑₜ=1 and cₚₒᵣₜ and cₙₑₜ>1.

The solution to the optimization problem which is posed in Definition 20 (ii) with free choice of the routing tree is considerably more difficult. The problem is generally too complex to solve it exactly. For this reason heuristic methods are explained in the following text in order to solve this problem. The solution to the optimization problem from definition 20 (i) with a defined routing tree in this case provides important strategies for good choice of the routing tree.

First of all, the special case will be explained in which cₚₒᵣₜ=cₙₑₜ=1.

Let us assume that q ε N undefined and that K ε κ. Without any restriction to generality, then Kₚₒᵣₜ=Eₚₒᵣₜ (otherwise consider u ε Vₚₒᵣₜ\g⁺(Kₚₒᵣₜ) not as an initial node, that is to say set Vₚₒᵣₜ:=g⁺(Kₚₒᵣₜ)).

Since cₚₒᵣₜ=1 it can easily be seen that

$${T}_{{c}_{port} , {c}_{net} , q}^{min} ( K ) \geq {}_{v ∈ {V}_{Port}}^{max}{d}{}_{k}^{} ( v ) = D ( K ) .$$

Equality therefore exists. In this context, let us assume that

$$n := \begin{matrix}max \\ v ∈ {V}_{Port}\end{matrix} {d}_{K} ( v ) = D ( K ) .$$

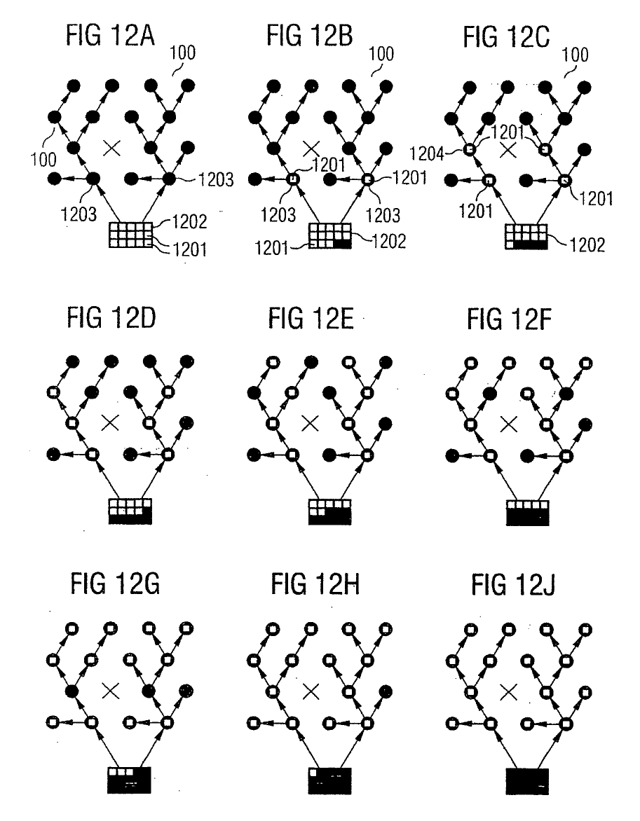

The idea of the following routing is that one electronic message will enter the initial nodes via each supply line in each clock cycle, and will be passed on step-by-step in the subsequent time intervals to their respective destination nodes, that is to say to the destination pixel processor. First of all, the messages are fed to the nodes which are further away, while later on the messages are fed to the nodes which are located close to the portal node, that is to say the pixel processor. Corresponding routing is illustrated in FIG. 12a to FIG. 12i for the case when cₚₒᵣₜ=cₙₑₜ=1. The small quadrilaterals each symbolize an electronic message 1201, which is passed via the portal node 1202 to the initial pixel processors 1203 into the pixel arrangement 100.
u ε Vₚₒᵣₜ is considered, and d:=d_{K}(u)=|v_{K}(u)| is set. It is assumed that
V_{K}(u)={v_{q}_{₁}, . . . v_{q}_{_{d}}} with v_{q}=u is arranged such that
Γ_{K}(v_{q}_{ᵢ}, v_{q}_{ⱼ})={ } (1)
for i>j. This is satisfied in particular, when
|γ_{K}(v_{q}_{ᵢ})≧|γ_{K}(v_{q}_{ⱼ})|
for i>j. Let us now assume that 1 ε { 1, . . . , d} undefined and that (kₚ_{₁}, . . . , kₚ_{_{z}}), z ε N, the path from w to v_{q1}.

Then, for all i ε {1, . . . , n} and j ε {1, . . . , r} set

$${σ}_{ij}^{ql} := \{ \begin{matrix}1 & if 1 + ( d - l ) \leq i \leq z + ( d - l ) and {p}_{i} - ( d - l ) = j , \\ 0 & else\end{matrix} \} .$$

In order to show that σ^{q1} defines a routing matrix v_{q1} it is sufficient to show that
z+(d−1)≦n,
this is because the n clock cycles are then sufficient to pass the message from σ^{q1} to its destination v_{q1} on the basis of our design.

On the basis of (1), 1≧z and thus
z+(d−1)≦d≦n
and this is thus shown.

On the basis of the above considerations, the σ¹ can finally be determined for all 1 ε {1, . . . , r} by consideration of all the initial nodes. As normal,

$$τ := {\sum }_{l = 1}^{r} {σ}^{l}$$

is formed.

It can easily be seen that T then actually defines a (1,1,q) routing via (V, K, g|K) for any q ε N and, on the basis of the above considerations, is optimum. Thus:

$${T}_{{c}_{port ,} {c}_{net} , q}^{min} ( K ) = \begin{matrix}max \\ v ∈ {v}_{port}\end{matrix} {d}_{k} ( v ) = D ( K ) .$$

FIG. 12a illustrates the initial state, in which all of the messages 1201 are stored in the portal node 1202. After a first clock cycle, the first two messages 1201 are supplied to the initial pixel processors 1203, that is to say to the pixel processors in the pixel arrangement 100 via which the information can be supplied via the pixel arrangement to the respective pixel processors, where they are buffer-stored (see FIG. 12b). After a further time step (see FIG. 12c), the first two messages have already been transmitted to first inner nodes 1204 in the pixel arrangement and two further messages 1201 have been supplied to the initial pixel processors 1203. After a further time step in each case the respective electronic message 1201 will always have been transmitted further by in each case one pixel processor, and two new messages 1201 will in each case have been supplied to the pixel arrangement 100, in other words being supplied to the initial pixel processors 1203. FIG. 12d, FIG. 12e, FIG. 12f, FIG. 12g, FIG. 12h and FIG. 12i illustrate the successive progress of the transmission of the messages as far as their respective destination pixel processor, after one clock cycle in each case.

As one possible advantageous strategy for the choice of an optimum routing with free choice of the routing tree in the sense of Definition 20 (ii), it can be stated:

Choose the routing tree such that all the initial nodes as far as possible have a throughput of the same magnitude (to be more precise, they differ by a maximum of the value 1), and set the routing matrix in accordance with the above statements.

The following text briefly explains the second special case, in which:
c:=cₚₒᵣₜ=cₙₑₜ>1, q>c.

Let us assume that K ε κ. Without restriction to generality, once again Kₚₒᵣₜ=Eₚₒᵣₜ.

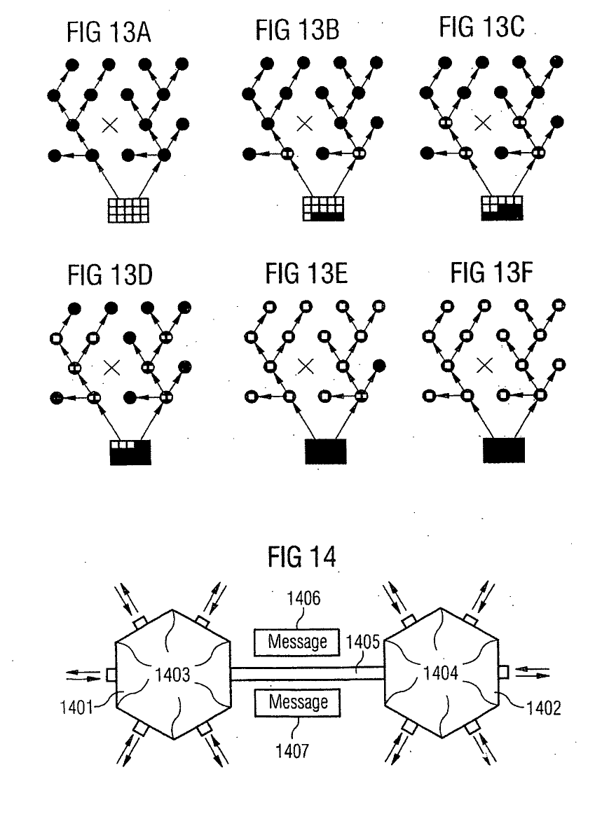

In this case, it is more difficult to state the minimum routing duration in advance. A routing matrix is thus developed which defines an optimum (cₚₒᵣₜ, cₙₑₜ, q) routing via (V,K,g|K). Finally, the minimum routing duration can be determined from this. The idea for this variant of the routing process is equivalent to that already developed for the case where cₚₒᵣₜ=cₙₑₜ=1 except that, in this case c=cₚₒᵣₜ=cₙₑₜ messages are always introduced at the same time into one initial node, in order to be passed on from there with that node which is furthest away and has not yet been notified. A routing process such as this is once again sketched in FIG. 13a to FIG. 13f.

First of all, let us assume that:

$$\tilde{n} := \begin{matrix}max \\ v ∈ {v}_{port}\end{matrix} {d}_{K} ( v ) .$$

It is assumed that u ε Vₚₒᵣₜ and that d:=d_{K}(u)=|V_{K}(u)|. It is assumed that V_{K}(u)=(v_{q}_{₁}, . . . , v_{q}_{_{d}}) where v_{q}_{₁}=u is arranged such that
|γK(v_{q}_{ᵢ})|≧|γ_{K}(v_{q}_{ⱼ})|
if i>j. It is assumed that 1 ε {1, . . . , d} and that

$$\hat{d} := ⌊ \frac{d - l}{c} ⌋ ,$$

that is to say the next smaller integer to

$$\frac{d - l}{c} .$$

It is assumed that (kₚ_{₁}, . . . , kₚ_{_{z}}) is the path from w to v_{q}_{₁}. Now, for all i ε {1, . . . , ñ} and j ε {1, . . . r} set

$${\tilde{σ}}_{ij}^{ql} := \{ \begin{matrix}1 & if 1 + \hat{d} \leq i \leq z + \hat{d} and {p}_{i - \hat{a}} = j \\ 0 & els e .\end{matrix} \} .$$

As before, in this way determine the concept \tilde{σ}¹ for all 1 ε {1, . . . , r} and set

$$\tilde{τ} := {\sum }_{1 = 1}^{r} {\tilde{σ}}^{1} .$$

Now delete all those lines in \tilde{τ}, which are equal to 0, that is to say set
n:=min{ñ ε N; τᵢⱼ=0 for all \hat{n}<i<ñ and j=1, . . . , r}
and
τ:=(\tilde{τ}ᵢⱼ)i=1, . . . , n
j=1, . . . , r

It can be shown that τ defines an optimum (cₚₒᵣₜ, cₙₑₜ, q) routing via (V,K,g|K) for any q≧c. Furthermore

$$⌈ \frac{D ( K )}{c} ⌉ = \begin{matrix}max \\ v ∈ {v}_{port}\end{matrix} ⌈ \frac{{d}_{K} ( v )}{c} ⌉ \leq n \leq \begin{matrix}max \\ v ∈ {v}_{port}\end{matrix} {d}_{K} ( v ) = D ( K )$$

$$and$$

$$L ( K ) \leq n .$$

The actual magnitude of n now depends on the specific structure of the branches of the initial nodes, but can easily be calculated. To do this, the number of clock cycles nᵤ which are required in order to route all the messages to the nodes in the branch of u is first of all calculated for each u ε Vₚₒᵣₜ. V_{K}(u) and d are in this case assumed to be as above. Then:

$${n}_{u} = {max}_{l ∈ \{ 1 , … , d \}} ( \vert {γ}_{K} ( {v}_{qt} ) \vert + ⌊ \frac{d - l}{c} ⌋ ) .$$

This results in the routing duration n becoming:

$${n}_{u} = \begin{matrix}max \\ u ∈ {v}_{port}\end{matrix} {n}_{u} .$$

An alternative strategy for the choice of optimum routing with free choice of the routing tree in the sense of Definition 20(ii) is thus:

Choose the routing tree such that all the initial nodes as far as possible have the same throughput and the tree is “sufficiently widely branched” in the branches of the initial nodes such that n comes as close to

$$⌈ \frac{D ( K )}{c} ⌉$$

as possible. Set the routing matrix in accordance with the above considerations.

“Sufficiently wide branching” is obviously present when the following statement is true for all the introduction nodes: consider the branch of the introduction node, and organize the associated nodes on the basis of increasing path length. The path lengths of the nodes should then increment only all c nodes by the value of 1, that is to say c nodes of the path length 2, c nodes of the path length 3 . . .

If the respective nodes and supply lines have small capacities, it is more important to ensure that there is a uniform throughput in the introduction node since, in this case, the throughput through the introduction nodes is normally the critical factor for the lower limit on the routing duration. In this case, the introduction nodes to a certain extent represent a constriction of the tree. If the capacities are higher, on the other hand, it is more important to ensure that there are a sufficiently large number of branches in the tree, and thus short path lengths. In this case, it is normally the path lengths which form the lower limit to the routing duration. In contrast, very high capacities are no longer worthwhile at all, since the hexagonal network limits the number of branches and certain minimum path lengths of the topology of the network, that is to say the topology of the networking or coupling of the pixel processors in the processor arrangement is predetermined.

Exemplary embodiments of the methods for self-organization of the pixel processors in the pixel arrangement will be explained in the following text.

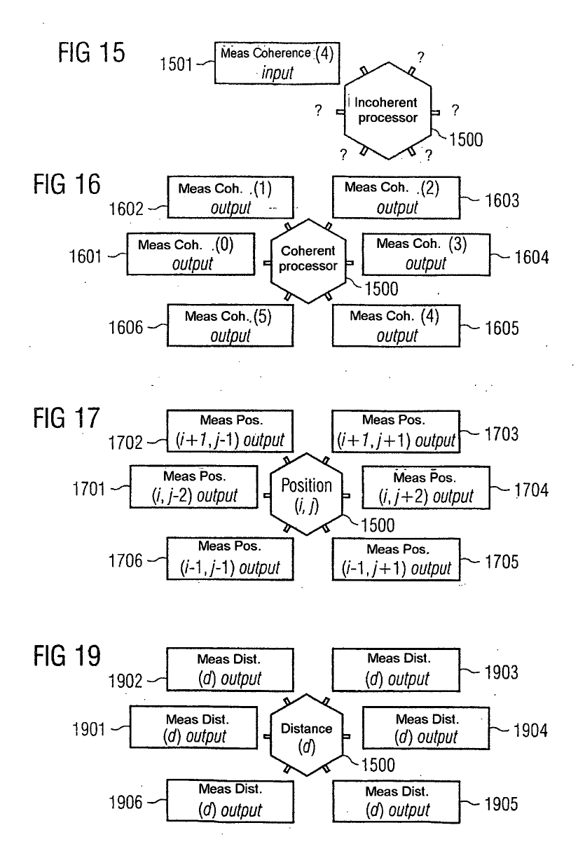

The exemplary embodiments are based on the assumption of the following situation:
The central external unit, that is to say the portal processor, does not know the topology of the network, that is to say the arrangement of the pixel processors in the processor arrangement.
The pixel processors are networked to one another by means of bidirectional links.
Direct communication takes place only between respectively mutually directly adjacent neighboring pixel processors.
The basis for communication is the interchange of electronic messages, for example, as illustrated in FIG. 14.
Each contact, together with other components for self-organization (position determination, creating of routing tables etc.) and for image construction is handled by different messages. FIG. 14 illustrates a first pixel processor 1401 with a hexagonal shape, as well as a second pixel processor 1402, likewise with a hexagonal shape. The first pixel processor 1401 has six bidirectional communication interfaces 1403, as is indicated in each case by a double-headed arrow in FIG. 14. The second processor unit 1402 also has six bidirectional communication interfaces 1404. The first processor unit 1401 and the second processor unit 1402 are coupled to one another via a supply line 1405, that is to say an electrically conductive connection, which may, of course, also be in the form of an optical communication link or a radio link, such that, not only is it possible to transmit a first message 1406 from the first processor unit 1401 to the second processor unit 1402, but it is also possible to transmit a second message 1407 from the second processor unit 1402 to the first processor unit 1401.

According to the present exemplary embodiments in the fault-free state, all of the pixel processors 1401, 1402 are completely networked to one another via the corresponding supply lines and the bidirectional communication interfaces.

The problem mentioned above is solved by self-organization based on local message interchange between two mutually directly adjacent processor units 1401, 1402.

The self-organization method thus comprises distributed uniform algorithms, which transmit these electronic messages via their communication interfaces.

During the course of the method, the processor units 1401, 1402 learn their alignment and their two-dimensional position within the processor arrangement, as well as the distance between the respective processor unit and the portal processor, in general a reference position. The reference position may also be the position of a processor unit which is located at the introduction point to the pixel arrangement. In further steps, routing paths between the individual processor units and the portal processor are marked locally. The algorithms for selection of the routing paths are in this case designed such that the routing duration is as short as possible, with a uniform information flow. The self-organization also defines the algorithm for distribution of the information using the pixel arrangement in the course of image construction, that is to say in order to display a digitized image on the pixel arrangement. Owing to the specific concept of the method, the shape of the pixel arrangement and hence also failed individual components are irrelevant, therefore resulting in a high degree of fault intolerance according to one embodiment of the invention.

The entire method comprises the combination of the following method elements:
uniform algorithm elements for message processing which are run by the pixel processors,
the control algorithm for the portal processor,
a message catalog, which represents the interface to the algorithm elements.

The following text is based on the assumption of hexagonal networking of the pixel processors within the pixel arrangement 100 without any restriction to generality.

In an orthogonal situation, or other two-dimensional network, however, the algorithms are transmitted according to one embodiment of the invention in a completely analogous manner to this description, as stated below.

According to one communication layer model, functions which are located underneath the functions required according to one embodiment of the invention, for example, ping messages, protection of the transmission by means of checksums, reception confirmation, requesting defective messages once again, etc. will not be considered in the following text. However, these can be implemented without any problems in the course of the invention.

For the method steps described in the following text, it can be stated in general that each pixel processor sets up a data record for each of its adjacent pixel processors on the basis of received messages, with this data record being used to store the information obtained in a memory that is associated with the respective processor.

In a first method element, the pixel processors learn a uniform alignment.

Since all of the connections of the portal processor are, on the basis of the above convention, linked to the introduction points by means of the south-west face on the corresponding initial pixel processors, this can be used in order to achieve coherence.

Measurement coherence messages are sent for this purpose, containing as the parameters, a number of connections by which the receiving connection is separated in the counterclockwise direction from the east direction, as defined above.

Each pixel processor is set to be incoherent for initialization purposes.

On receiving a measurement coherence message 1501 (see FIG. 15), the processor unit 1500 which receives the measurement coherence message 1501 carries out the following steps:
1. If the processor unit 1500 is already coherent, the processing is ended.
2. The easterly direction is determined on the basis of the message parameter, and all of the connection designations/connection numberings are aligned appropriately.
3. The processor unit 1500 is set to be coherent.
4. Measurement coherence messages 1601, 1602, 1603, 1604, 1605, 1606 are sent via all of the connections from the processor unit 1500, whose parameters are in each case chosen such that the processor units 103 which receive the respective measurement coherence message 1601, 1602, 1603, 1604, 1605, 1606 can align themselves correctly in the above manner (see FIG. 16).

The method element for uniform alignment is started by the portal processor transmitting the measurement coherence message (2) with the parameter value 2 to the respective introduction pixel processors via its connections. The method element is terminated when the last processor unit has become coherent.

The number of clock cycles required to carry out the process corresponds to the maximum distance between a pixel processor and the portal processor. One or two more clock cycles may also possibly be required before the final message communication “dies”.

In a further method element, the pixel processors interchange electronic messages between one another in order to automatically determine their local position within the pixel arrangement.

Since the hexagonal array of pixel processors within the pixel arrangement in each case comprises offset rows, the coordinate system is selected according to this exemplary embodiment such that the column numbers in the rows are alternately even or odd.

In this context, it should be mentioned that, if the pixel arrangement structure is orthogonal, the coordinate system can very easily be chosen canonically.

In the case of a hexagonal array, the procedure described above makes it possible for a processor to determine the positions of its adjacent pixel processors, independently of the geometry of the pixel arrangement, from its own position (i, j) in the row i and column j.

The respective positions are illustrated in FIG. 17 for the processor unit 1500. As can be seen from FIG. 17, the agreed convention is that the column numbers rise from west to east (from left to right) and that the row numbers increase from south to north (from bottom to top).

For position determination according to this exemplary embodiment, measurement position messages 1701, 1702, 1703, 1704, 1705, 1706 are interchanged, which contain two parameters, specifically the row number and the column number, which the processor unit sending the measurement position message 1701, 1702, 1703, 1704, 1705, 1706 has calculated as the position as shown by it for the processor unit receiving the respective message 1701, 1702, 1703, 1704, 1705, 1706.

The position of each pixel processor is defined as (0,0) for initialization purposes. The process of position determination starts in each pixel processor as soon as it has become coherent, as has been explained above.

The measurement position messages 1701, 1702, 1703, 1704, 1705, 1706 are then sent via all the connections, as illustrated in FIG. 17.

On receiving a measurement position message 1701, 1702, 1703, 1704, 1705, 1706 with a row parameter z and a column parameter s, the respective receiving processor unit carries out the following steps:
1. If z>i, where i represents its own row number, then i is set to be equal to z.
2. If s>j, where j is its own column number, then j is set to be equal to s.
3. If step 1 or step 2 results in change in its own position (i, j) then measurement position messages 1701, 1702, 1703, 1704, 1705, 1706 are sent via all of the connections, as is illustrated in FIG. 17.

The method element is ended when no more position changes occur.

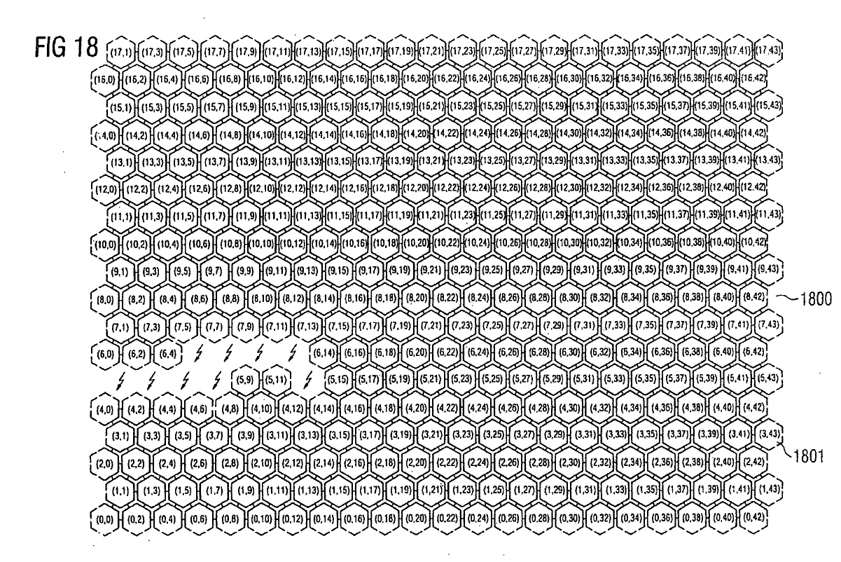

FIG. 18 illustrates an example of the processor arrangement 1800 with various defects, which has automatically determined the positions of the individual processors on the basis of the procedure described above. Both failed, that is to say faulty, processors and failed connections were used according to this exemplary embodiment. This exemplary embodiment will also be used in the further course of this description in two variants with a different number of initial processor units in order to describe the other method elements.

The number of clock cycles required to carry out the process is limited as a maximum of a maximum distance between a pixel processor and another pixel processor in the processor arrangement. One or two more clock cycles may also be required before the last message communication “dies”. Normally, however, the method element can generally be carried out even more quickly, depending on the geometry of the processor arrangement in 1800.

In this context, it should be noted that, in the representation of hexagonal pixel images or orthogonal pixel images, the portal processor always produces a map on to the coordinate system of the processor arrangement 1800 determined in this way. During the formation of routing paths, which is carried out in a subsequent method element, the information which has now been stored locally is transmitted to the portal processor, so that it is possible to produce an appropriate map in the portal processor.

The local position of the respective pixel processor 1801 within the processor arrangement 1800 is shown in the form of a value tuple in the pixel arrangement in FIG. 18, in each case for each pixel processor 1801.

In an additional method element, the respective distance between a processor unit and the portal processor, that is to say the length of the path from the pixel processor to the portal processor (see also Definition 6) is determined, in general the distance between a processor unit 1801 in the processor arrangement 1800 and a predetermined reference position.

In order to initialize this method element, the distance between each processor unit 1801 is defined to be “infinite”. According to this exemplary embodiment, the distance between each pixel processor and the portal processor is defined as a value which is greater than the maximum value, which may be assumed to be the distance within the pixel arrangement.

Without any restriction to generality, it is assumed that the steps in the method elements described above have already been carried out.

The process of distance determination is then started via the portal processor by sending measurement distance (0) messages to the processor units at the introduction points to the processor arrangement 1800.

On receiving a measurement distance message with a distance parameter a, the processor unit which in each case receives the measurement distance message carries out the following steps:
1. If d≧a+1, where d represents its own distance, then d is set to be equal to a+1.
2. If step 1 has resulted in a change in its own distance d, then measurement distance messages 1901, 1902, 1903, 1904, 1905, 1906 are sent via all the connections to the respectively adjacent processor units (see FIG. 19). Each measurement distance message 1901, 1902, 1903, 1904, 1905, 1906 in each case contains as a parameter the distance value which the processor unit 1500 determined in the preceding step.

The method element is terminated when no more distance changes occur.

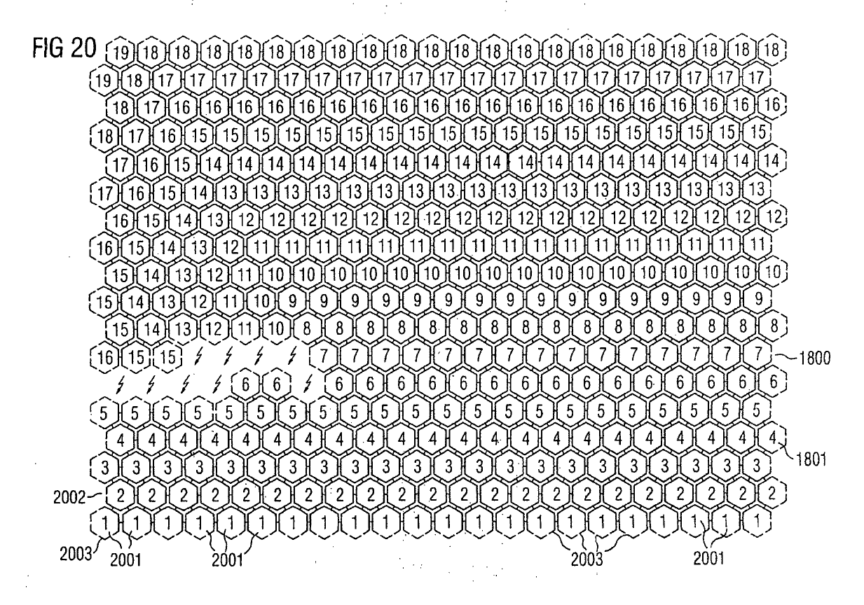

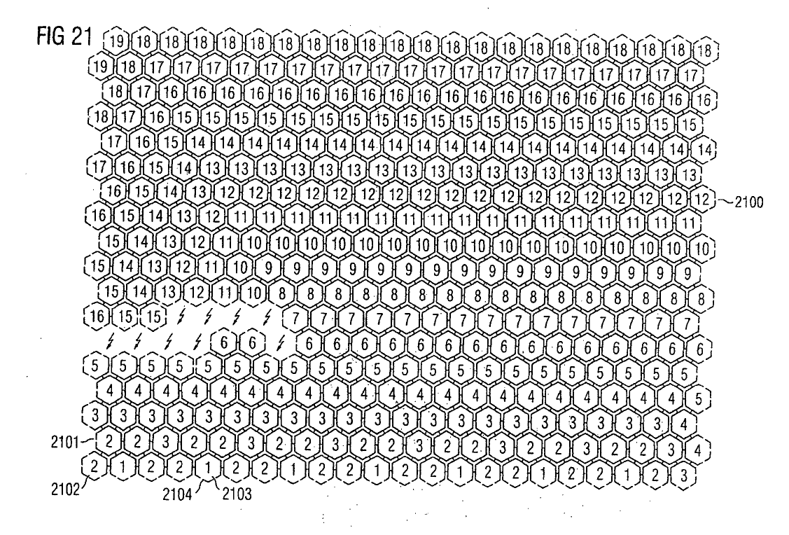

FIG. 20 and FIG. 21 illustrate the processor arrangement 1800 based on a first exemplary embodiment, and a processor arrangement 2100 based on a second exemplary embodiment, in which, in the case of the processor arrangement 1800 according to the first exemplary embodiment, all of the processor units 2001 in the lowermost row 2002 of the processor arrangement 1800 are coupled to the portal processor via their south-west side 2003.

In the processor arrangement 2100 according to the second exemplary embodiment, the lowermost row 2101 in the processor arrangement 2100 contains both processor units 2102 which are not coupled to the portal processor, as well as processor units 2103 which are coupled to the portal processor via their communication interfaces 2104, which are arranged on the south-west side. According to the second exemplary embodiment, every third processor unit in the lowermost row 2101 is connected to the portal processor via its communication interface located on the south-west side.

The number of clock cycles required to carry out the process corresponds to the maximum distance between one processor unit and the portal processor. Once again, one or two more clock cycles may also be required until the final message communication “dies”.

In this context, it should be noted that each processor unit can store the distance between its direct adjacent processor units and the portal processor on the basis of the respectively received messages, for subsequent local use.

In this method element, the processor unit's own distance value is obviously changed in an iterative process when the previously stored distance value is greater than the received distance value increased by a predetermined value in the respectively received message. For the situation where a processor unit changes its own distance value, it produces a measurement distance message, and sends this via all the communication interfaces to adjacent processor units, with the measurement distance message in each case including its own distance as distance information or the distance value for the distance between the receiving processor unit and the portal processor, a value which is increased by a predetermined value on its own distance value, and a distance value which is increased by the value “1”.

The method element for regular backwards organization will be described in the following text.

In order to make it possible to carry out the following method steps, it is necessary for the distance between a pixel processor and a respective reference position to have been determined, and for it thus to be known, and stored as respective distance information in the memory of the respective processor.

In the method element described in the following text, the connections between the respective processor units are referred to in the following text as instances which are denoted channels.

The sets of the processor units with the portal processor as the root node and the channels as edges between the respective processor units form a tree. This tree is used for the subsequent routing, as has been described above in conjunction with graph-based theoretical principles.

The channels are defined in the regular manner such that each processor unit is connected by the shortest path to the portal node.

For initialization purposes, each pixel processor 1500 is defined as being “unorganized”. The organization process is started over all the connections by the portal processor transmitting measurement organize messages 2201, 2202, 2203, 2204, 2205, 2206 which have no parameters whatsoever.

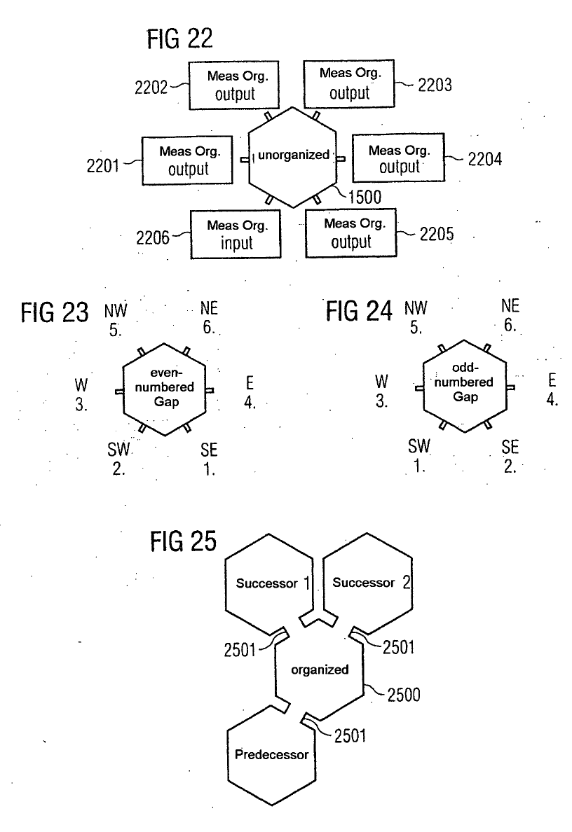

On receiving a measurement organize message 2201, 2202, 2203, 2204, 2205, 2206 the processor unit which in each case receives the message carries out the following steps:
1. If the processor unit is already organized, the processing is ended.
2. Additional measurement organize messages are sent via all the connections with the exception of the receiving connection, that is to say the connection via which the measurement organize message 2201, 2202, 2203, 2204, 2205, 2206 has been received (see FIG. 22).
3. The processor unit uses the previously determined distance information to determine an adjacent processor unit which is closer to the reference position than it is itself, thus being closer to the portal processor. That adjacent processor unit is selected and is defined as the “predecessor” which is the first to be at a shorter distance from the processor unit on the basis of the sequence defined in FIG. 23 and FIG. 24. The connection between the processor unit and its “predecessor” is recorded in particular and is referred to as a “channel”. The set of pixel processors with the portal processor as a node and the channels as edges then forms a tree. In the case of a regular display without any faults, this procedure leads to a “zigzag pattern” for the definition of the channels.
4. A measurement channel message is sent to the “predecessor”, and the processor unit is set to be organized.

On receiving a measurement channel message, the processor which receives the measurement channel message defines the sender as a “successor”. In a corresponding manner, the connection between the processor unit and the “successor” is then a channel.

The method element is terminated once all of the processor units have been organized in this way.

By way of example, FIG. 25 illustrates an organized processor unit 2500, with the connections 2501 (which are channels) being visually emphasized. The pixel information, for example, thus the image information to be displayed, is routed via the channels 2501 during use of the display.

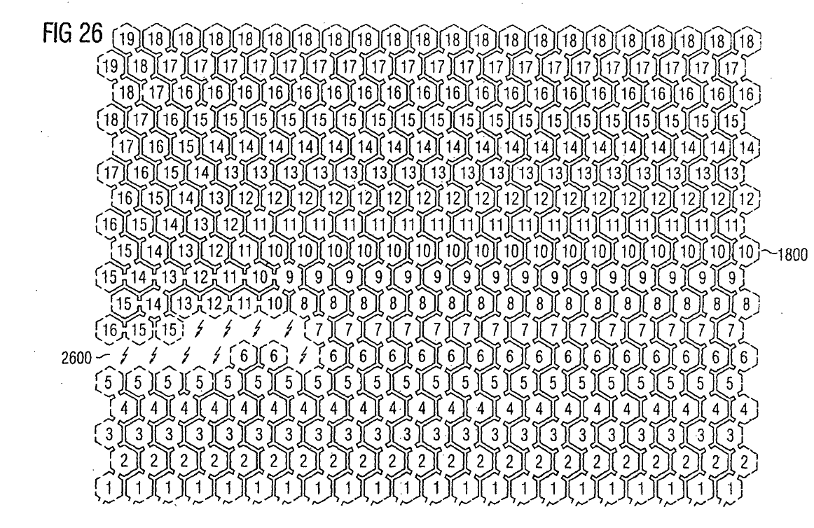

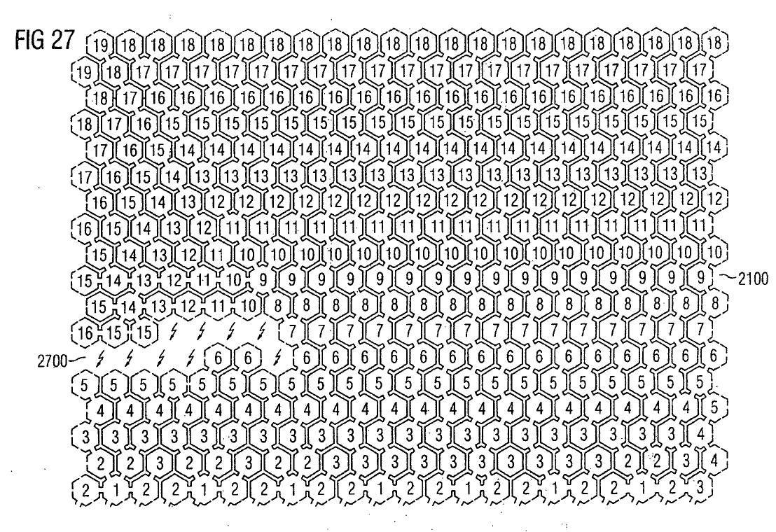

FIG. 26 and FIG. 27 illustrate examples of the processor arrangement 1800 and 2100 once the automatic organization process has been carried out, as described above.

The number of clock cycles required to carry out the method element for self-organization in the backwards direction, corresponds to the maximum distance between a pixel processor and the portal processor. In this case as well, one or two more clock cycles may be required before the last message communication “dies”.

The regular backwards organization leads to well-balanced trees for fault-free rectangular displays, that is to say display units.

Since all of the processor units within the processor arrangement 1800, 2100 are connected to the portal by the respectively shortest path, this algorithm determines an element in the “optimum set” O₁, as defined above. In the case of horizontal cracks 2600, 2700, as illustrated in FIG. 26 and FIG. 27, the procedure described above leads to a situation, however, in which components of the processor arrangement 1800, 2100 which are shadowed by the crack are essentially supplied by a single supply line from the portal to the display. Additional alternative options for the organization process will therefore also be described in the following text.

The throughput of a pixel processor is of considerable importance for setting up routing tables.

The throughput is the number of pixel information items which must in each case be processed or passed on for this processor to construct an image.

The mathematical definition of the throughput is given above in Definition 6.

This number is identical to the number of pixel information items which are received via the input channel.

In order to carry out the following method element steps, a tree structure must have been organized in the process arrangement 1800, 2100, for example by means of channels, as described above.

The method element is started by the portal processor by sending measurement count notes messages, which have no parameters, via all of the connections to the respective introduction processor units.

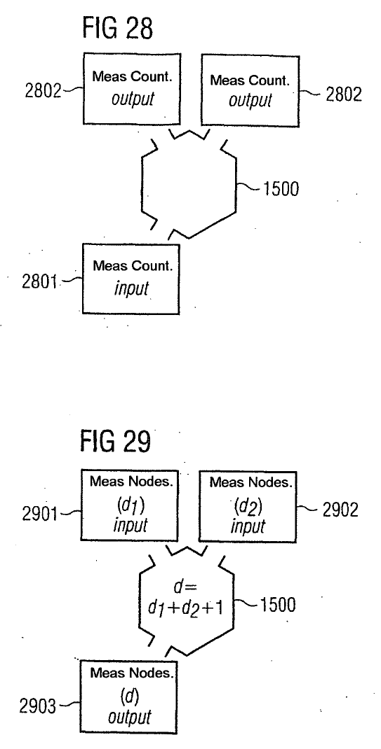

On receiving an incoming measurement count nodes message 2801 via the input channel, the respective processor receiving the measurement count nodes message carries out the following steps:
1. Measurement count nodes messages 2802 are in turn sent via all of the output channels from the processor unit receiving the measurement counts nodes message, as illustrated in FIG. 28.
2. All of the adjacent processor units which are connected to one another via output channels are marked with a throughput having the throughput value “0”.
3. If there are no output channels, its own throughput is set to the throughput value “1” and a measurement nodes size message 2901 is sent via the input channel to the respective predecessor process unit. FIG. 29 illustrates two incoming measurement nodes size messages for a processor unit 1500, a first incoming measurement nodes size message 2901 which contains the value d₁, and a second incoming measurement nodes size message 2902 with the parameter d₂ On receiving a measurement nodes size message with the throughput parameter \hat{d} via an output channel, the processor unit receiving the measurement nodes size message carries out the following steps:
   1. The adjacent processor unit from which the measurement nodes size message 2901, 2902 was received is marked with the throughput parameter of the measurement nodes size message.
   2. When at least one output channel is marked with a throughput with the throughput value “0”, the processing is ended.
   3. If all of the output channels are marked with a throughput value greater than “0” then its own throughput d is calculated as the sum of all the output throughputs +1.
   4. An additional measurement nodes size message 2903 is generated by the processor unit and is sent via the respective input channel with the throughput value d, which is obtained in accordance with the following rule d=d₁+d₂+1 on the basis of the exemplary embodiment described above.

The method element is terminated once the portal processor has received a measurement nodes size message via all of the connections.

The number of clock cycles required to carry out the method element corresponds to twice the maximum distance between a pixel processor and the portal processor. In this case as well, one or two more clock cycles may also be required before the last message communication “dies”.

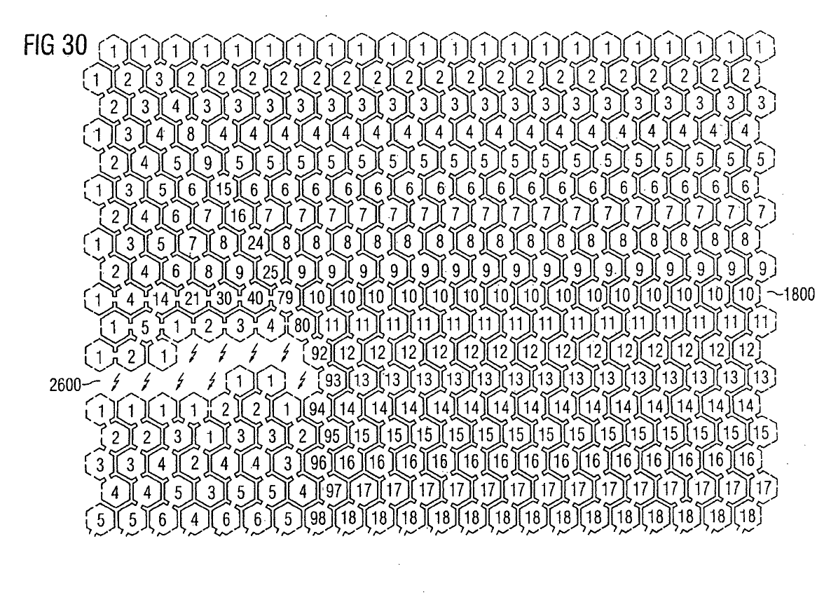

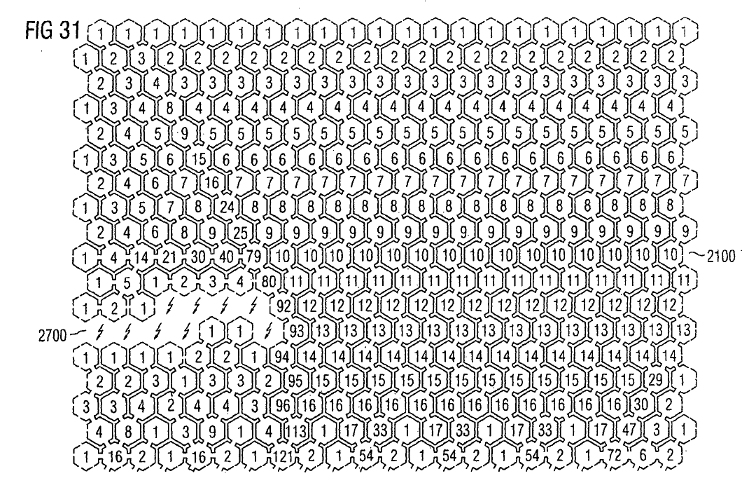

FIG. 30 and FIG. 31 illustrate examples of the processor arrangement 1800 and 2100, respectively, once the throughputs have been determined automatically in the manner described above.

The respective throughput value is stated in the respective pixel processors. These examples show that throughputs are very high for those introduction processor units which have to supply the region of the respective processor arrangement 1800 or 2100 which is shadowed by the respective horizontal crack 2600, 2700.

The following text therefore describes an alternative organization method, which can react even more flexibly to the faults, that is to say to defects and irregular shapes of a processor arrangement 1800, 2100.

In order to achieve a throughput which is as uniform as possible, a heuristic solution approach for the selection of a routing tree comprises the successive transmission of so-called measurement token messages, which “occupy spaces” in the processor arrangement 1800, 2100.

By analogy with the gradual coloring of the processor arrangement 1800, 2100 by means of color streams, each introduction point is sent a different “color” with the token. This results in the processor arrangement 1800, 2100 being subdivided into color regions, which are each supplied from the portal node via an introduction processor unit.

In other words, this means that one “color” or an individual marking is in each case provided for each processor unit that is supplied via a respective introduction processor unit.

In the following text, the expression “color” is used for clearer representation purposes and an area which is marked with the same marking is, in a corresponding manner, referred to as a “color region”.

The following heuristic strategies are used for distribution:
A token weight determines the amount by which the distance to the portal node may be increased, as a maximum, on the basis of the coloring.
Once pixels have been colored, that is to say processor units, they remain colored, or in other words they remain marked.
The processor unit sending the token becomes the “predecessor”, and the connection to it the channel. In the following text, the colored pixels, that is to say the marked processor unit, only accepts the token from the respective predecessor.
The token is sent via channels.

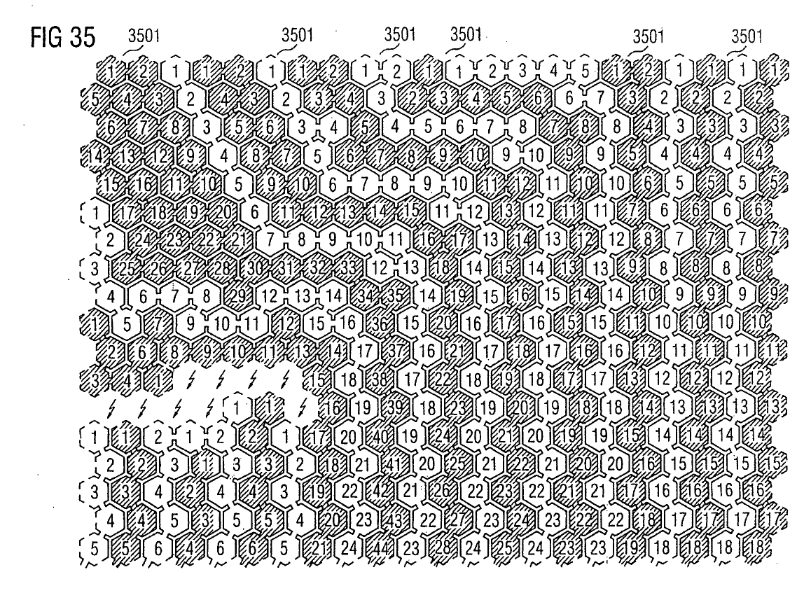

After the complete coloring of the processor arrangement 1800, 2100, reorganization is necessary within the colored areas since the method element does not result in the formation of optimum “meandering channels” 3501, as illustrated by way of example in FIG. 35.

First of all, the method element for processing of the messages used for token allocation will be described in the following subsections.

The distance determination within a color region is very largely identical to the general distance determination process as described above, to a reference position.

The color distance in this case determines the length of the shortest path from a processor unit to the portal processor, in which case all of the processor units on the path must belong to the same color region.

For initialization, the color distance for each processor unit is defined as being infinite, and its color is undefined. According to this exemplary embodiment, the distance between each pixel processor and the portal processor is defined as a value which is greater than the maximum value which can be assumed to be the distance within the pixel arrangement. The processor unit likewise marks its adjacent processor units as being undefined, colored with the color distance infinite.

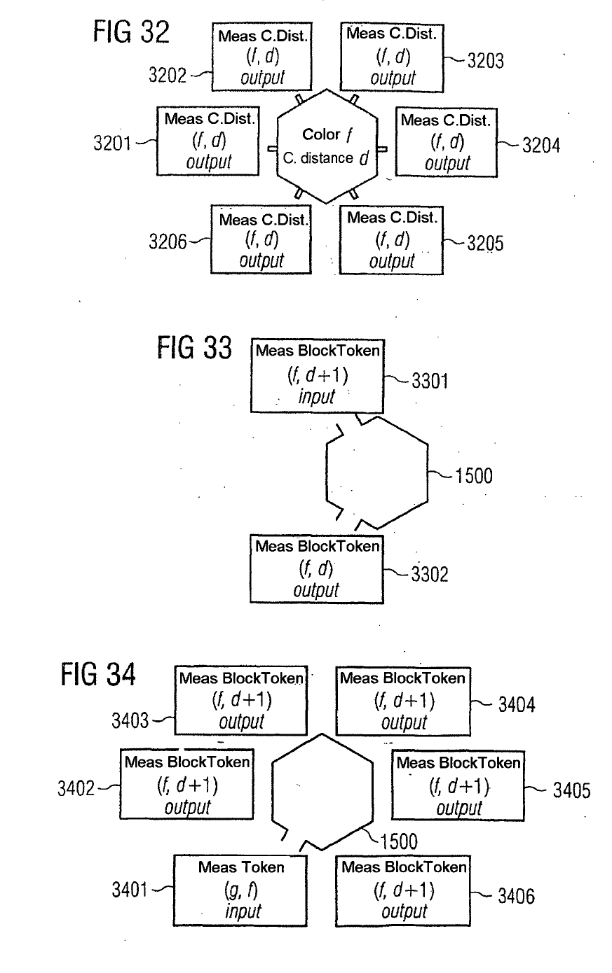

On receiving a measurement color distance message, with the color c and the color distance parameter a, the respective processor unit receiving the measurement color distance message carries out the following steps:
1. The processor unit sending the measurement color distance message is marked with the color c and the color distance a.
2. If the color c does not match its own color f, that is to say the color f of the processor unit receiving the measurement color distance message, then the processing is ended.
3. Its own color distance d is set as the minimum of the color distances of neighbors which are marked with the same colors plus the value 1.
4. If step 3 has resulted in a change to its own color distance d, then measurement color distance messages 3201, 3202, 3203, 3204, 3205, 3206 with the parameters (f, d) that is to say in other words with their own color distance d and their own color f, are sent via all of the connections (see FIG. 32).

According to one embodiment of the invention, measurement block token messages are used to block adjacent processor units against received token messages, that is to say that once a measurement block token message such as this has been received, no more tokens may be sent to these blocked adjacent processor units.

At the same time, the color and color distance are signaled in the same way as for the measurement color distance message.

For initialization purposes, all of the adjacent processor units to a processor unit are set to be unblocked.

On reception of an incoming measurement block token message 3301 with the color c and the color distance parameter a as message parameters, the respective processor unit receiving the measurement block token message carries out the following steps:
1. The processor unit sending the measurement block token message is set to be blocked, and is marked with the color c and the color distance a.
2. If the color c does not match its own color f, that is to say the color of the processor unit receiving the measurement block token message, the processing is continued with step 5, described further below.
3. Its own color distance d is set as the minimum of the color distances of adjacent processor units marked with the same color, plus the value 1.
4. If step 3 has resulted in a change in its own color distance d, then the processor unit sends measurement color distance messages 3201, 3202, 3203, 3204, 3205, 3206 via all the connections with parameters (f, d) as illustrated in FIG. 32.
5. If there is an input channel and all the adjacent processor units are set to be blocked, then a measurement block token message 3302 is produced with the parameters (f, d) and is sent via the input channel as is illustrated in FIG. 33.

According to one embodiment of the invention, so-called measurement token messages are used for coloring, that is to say for marking processor units and thus for definition of color regions, that is to say areas to be marked within the processor arrangement 1800, 2100.

With regard to the processing of measurement token messages, a distinction should be drawn between whether the processor unit is still uncolored or has already been colored by a token.

On reception of an incoming measurement token message 3401 with the weight g and the color f as message parameters, an uncolored processor unit which receives the measurement token message 3401 carries out the following steps:
1. The color distance pd, which is potentially its own, is set as the minimum of the color distances of adjacent processor units, colored with the color f, +1.
2. If the weight is g≦pd−a where a is the distance (not the color distance!) between the processor unit and the portal processor, then the processor unit sending the measurement token message 3401 is sent a measurement block token message, and the processing is ended (the propagation of the tokens is thus restricted by a relaxed distance).
3. The processor unit sending the measurement block token message 3401 is set to be blocked. Its own color is set to be f, and its own distance to be pd.
4. The processor unit sending the measurement token message 3401 is sent a measurement channel message, and the processor unit is set as being organized. The input channel is thus defined.
5. Measurement block token messages 3402, 3403, 3404, 3405, 3406 are sent via all the connections with the exception of the input channel of the processor unit 1500, as is illustrated in FIG. 34, in order to prevent token allocation from there.
6. If all of the adjacent processor units are set as being blocked, then a measurement block token message 3402, 3403, 3404, 3405, 3406 is sent via the input channel, as illustrated in FIG. 33.

On reception of a measurement token message with the weight g and the color f via the input channel, an already colored processor unit, in contrast, carries out a different procedure.

Let us consider a sequence R=(SE, SW, E, W, NE, NW), which corresponds to a sequence R of (south-east, south-west, east, west, north-east, north-west) for an even column number, and a sequence R=(SW, SE, W, E, NW, NE) which corresponds to a sequence (south-west, south-east, west, east, north-west, north-east) for an odd column number with the following method steps being carried out:
1. If the received measurement token message did not come via the input channel or the color f did not match its own color, the processing is ended.
2. If there is an unblocked output channel after the sequence R, then this output channel is used to send a measurement token message with the parameters (g, f) that is to say the token is passed on and the processing is ended.
3. If there is an unblocked connection after the sequence R, then this connection is used to send a measurement token message (g, f) and the processing is ended.
4. A measurement block token message is sent via the input channel, since the token cannot be passed on.

Since the channels cannot be set optimally for the choice of the color regions, owing to the method element described above, as is illustrated in FIG. 35, these channels are deleted by means of measurement delete channels messages, and are subsequently reset. In order to terminate the method element, the message is provided with a parameter “stamp”, whose value is not identical to the correspondingly stored parameter in the processor unit.

In this context, it should be noted that the portal processor uses a different parameter “stamp” for each reorganization process.

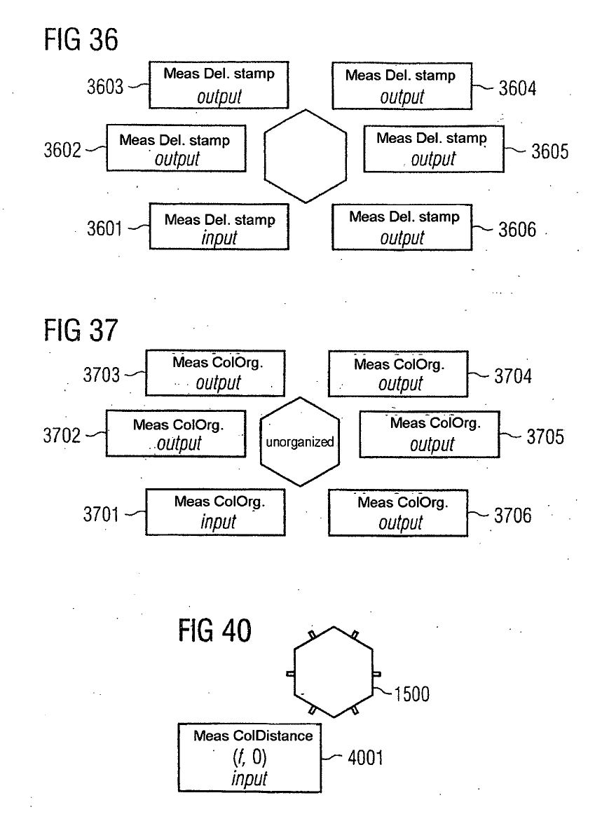

On reception of an incoming measurement delete channels message 3601 with the parameter “stamp”, the processor unit receiving the respective measurement delete channels message carries out the following steps:
1. If its own stamp parameter is identical to the received parameter value “stamp”, the processing is ended.
2. Its own stamp parameter is set to the value in the measurement delete channels message “stamp”.
3. All the channels are deleted.
4. Measurement delete channels messages 3602, 3603, 3604, 3605, 3606 with the parameter “stamp” are sent via all of the connections with the exception of the connection for the processing unit sending the measurement delete channels message, as is illustrated in FIG. 36.

After deletion of the old channels, new channels are set within a color region by the use of measurement color organize messages.

The processing of incoming measurement column organize messages 3701 and the sending of measurement column organize messages 3702, 3703, 3704, 3705, 3706 are very largely identical to the processing of measurement organize messages as described above.

However, one difference is that the adjacent processor units under consideration must have the same colors as the processing processor unit, and that the color distance is used as the criterion rather than the distance.

In order to carry out the method element described above, all of the described steps as far as the distance determination should have been carried out as explained above in the pixel array.

The connections are specifically identified as “channels” as above in the first exemplary embodiment.

In a first step, the portal processor in each case sends a measurement color distance message 4001 (see FIG. 40) with the parameters (f, 0) but with a different color parameter f via all of the connections. All of the adjacent processor units thus mark the portal processor with a different color.

This ensures individual and unique marking in each case, starting from each initial processor unit.

In a second step, the portal processor sends successive measurement token messages with the parameters (g, f) and with an identical weight g ε N₀ but a different color parameter f via all of the connections, in order to color all of the processor units in the processor arrangement 1800, 2100.

The method element is terminated when measurement block token messages have arrived via all the connections of the pixel processor, that is to say when the processor arrangement 1800, 2100 has been colored in completely.

In this context, it should be noted that the entire processor arrangement 1800, 2100 can always be colored in completely using this method.

FIG. 38 illustrates the processor arrangement 2100 for the situation where it has been colored with the weight g=4, and for which the throughput has been represented on the basis of the organization. As can be seen, in comparison with FIG. 30, which was formed by means of regular backwards organization, the tree is considerably better balanced.

However, meandering paths 3801 are formed on the basis of the configuration of this method element within the colored areas, so that the processor units are not connected by the shortest possible distance to the portal processor.

In a third step, the portal processor therefore sends a measurement delete channels message via all of the connections, as explained above, in order to delete the channels that have been formed. Directly after this message, a measurement color organize message is sent via all of the connections, and forms new channels within the colored areas, with these new channels representing the shortest connections.

The method element is terminated once all of the processor units have been organized in this way. The number of clock cycles required to carry out the processes corresponds to the maximum color distance between a pixel processor and the portal processor. In this case as well, one or two more clock cycles may also be required before the last message communication “dies”.

The routing tree that is produced depends on the weight g which is contained as a parameter in the respective measurement token message.

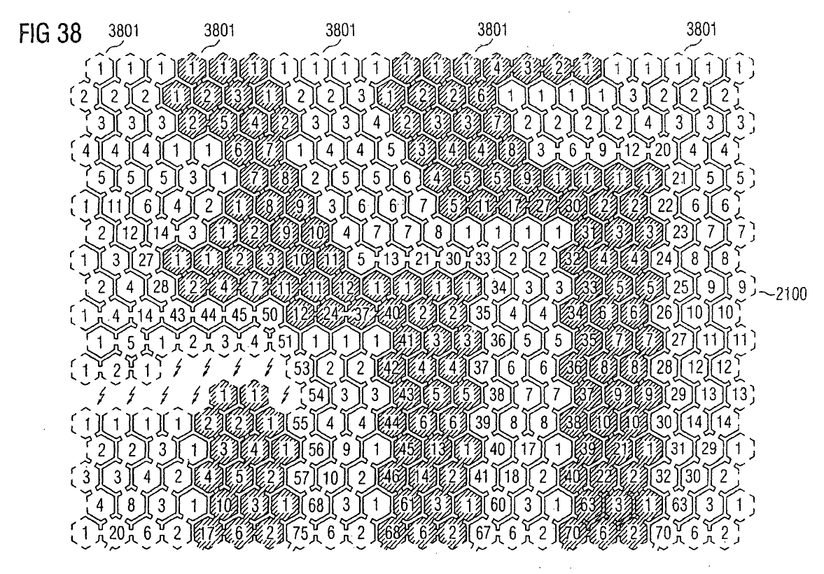

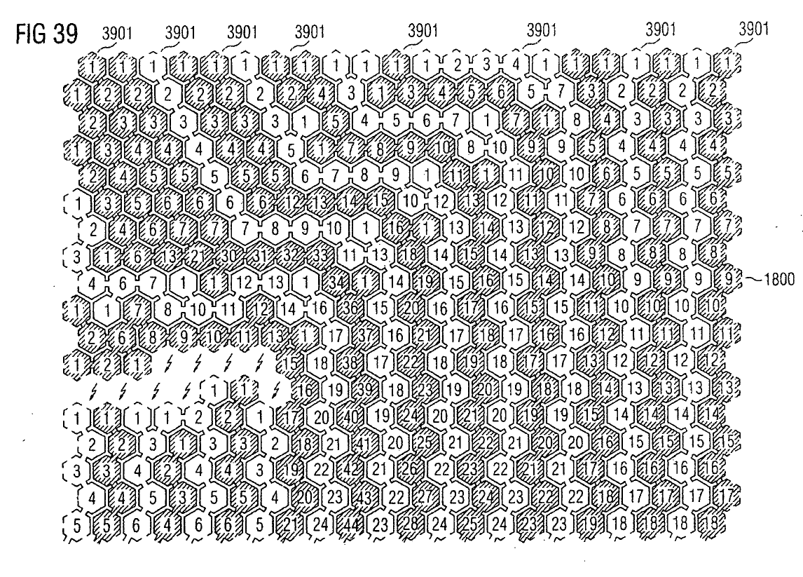

FIG. 39 illustrates the processor arrangement 1800 once reorganization has been carried out with the weight g=4, and the corresponding meandering paths 3901.

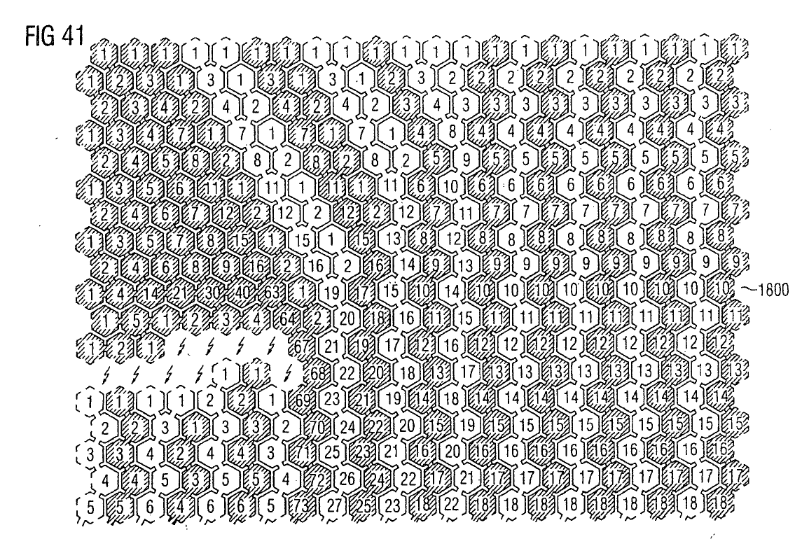

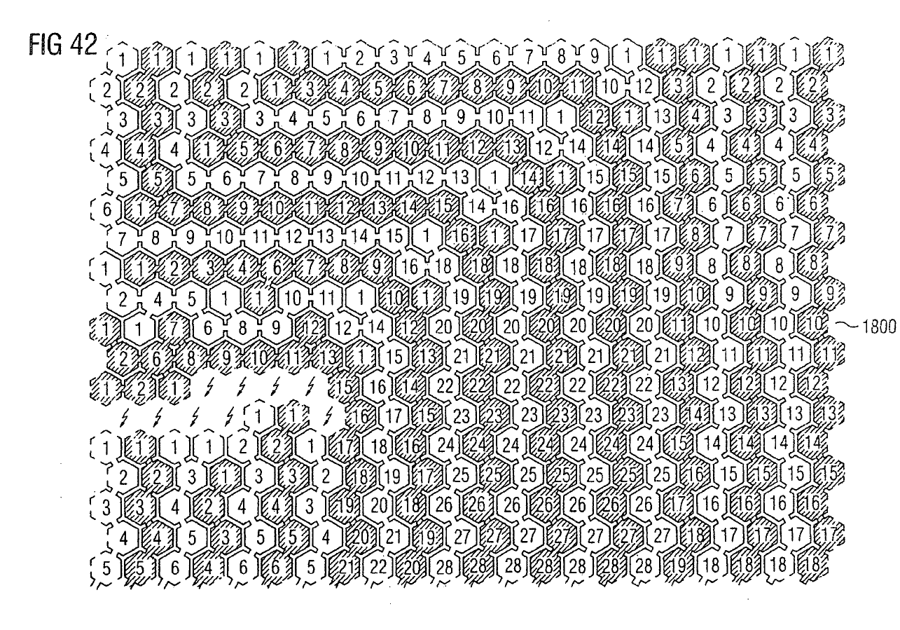

The weight g indicates by how many the color distance of a processor unit may be greater than the distance itself. The greater the weight g, the better the resultant tree is normally balanced, but also the longer the paths normally are in this tree. In order to explain this, reference should be made to FIG. 41, which illustrates the processor arrangement 1800 after formation of the meandering paths with the weight g=0, and to FIG. 42, which illustrates the processor arrangement 1800 after formation of the meandering paths with the weight g=∞.

The best choice for the weight normally depends on the transport characteristics of the respective connections, that is to say how many messages can be sent per clock cycle via one connection. The smaller this number, the greater the best weight must normally be.

Two methods for selection of a routing tree have been described above.

Once a routing tree has been chosen, that is to say once the corresponding channels have been chosen, then optimum routing for this tree can be determined very easily. The principles relating to this have been explained in conjunction with the description of the theoretical graph principles.

In a first step, all of the pixel processors, that is to say the processor units within the processor arrangement 1800, 2100, are numbered successively.

The numbers are then used as destination addresses for the routing process. In a second step, the local information which has been gathered is transmitted from the respective processor units to the portal processor. The overall routing table is then created in the portal processor.

According to this exemplary embodiment, measurement numbering messages are used for successively numbering all of the processor units in the pixel arrangement 1800, 2100. This is dependent on the throughput of the respective processor units already having been determined, for example, using the method element described above.

The numbering method element is started by the portal processor by sending measurement numbering messages 4301 via the output channels of the portal processor with these messages being transmitted to the initial processor units.

Once throughputs d₁, d₂, d₃, . . . have been determined for the corresponding adjacent processor units, the respective measurement numbering message 4302 is transmitted with the parameters 1, 1+d₁, 1+d₁+d₂, . . . as message parameters.

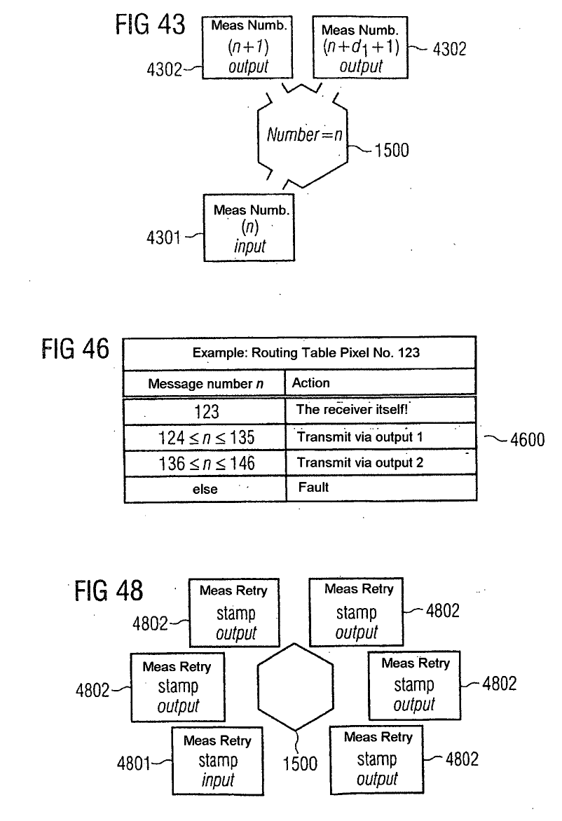

After reception of a measurement numbering message 4301 with the parameter n via the respective input channel of the processor unit (see FIG. 43), the processor unit receiving the measurement numbering message 4301 carries out the following steps:
1. The processor unit's own number is set to the value n, which corresponds to the value of the received measurement numbering message 4301.
2. One additional measurement numbering message 4302, which is produced by the processor unit, is in each case produced via all of the output channels of the processor unit and is sent with the parameters n+1, n+d₁+1, n+d₁+d₂+1, . . . , where d₁, d₂, . . . are the throughputs of the corresponding adjacent processor units.

The method element is terminated when the last processor has been successively numbered by the last processor unit. The number of clock cycles required to carry out the method element corresponds to the maximum distance to a processor unit via channels from the portal processor. With this method element as well, one or two more clock cycles may still be required before the last message communication “dies”.

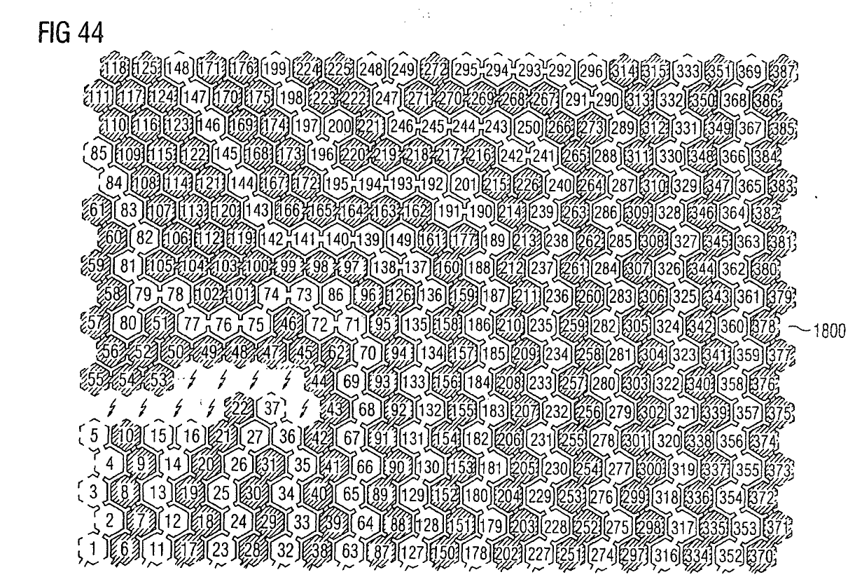

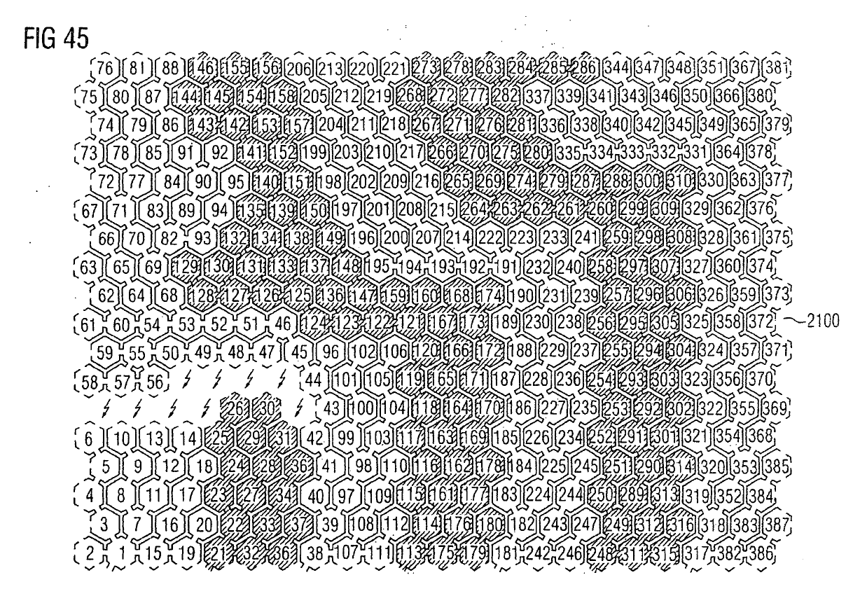

FIG. 44 and FIG. 45 illustrate the pixel arrangements 1800 (FIG. 44) and 2100 (FIG. 45) after the individual processor units within the respective pixel arrangement have been numbered.

The number of a processor unit can easily be used as an address for routing of data or images, since each output channel of a processor unit is allocated a unique number interval. Each processor unit can thus set up a simple routing table.

By way of example, the example illustrated in FIG. 45 shows the table for the processor unit numbered with the number 123, as illustrated in the routing table 4600 in FIG. 46.

The locally produced information is signaled to the portal processor by means of measurement collect information messages, which contain the following message parameters.
the position of the respective processor unit within the respective pixel arrangement, that is to say the row and the column in which the processor unit is located,
the pixel number,
the distance value used to indicate the distance from the processor unit to the portal processor,
the color distance, and
the throughput of the processor unit.

The measurement collect information messages are each sent from the processor units as soon as the respective processor unit has been successively numbered.

This information allows the pixel processor on the one hand to map pixel images onto the actual pixel array (sampling), and on the other hand to route this image data with the aid of the pixel numbers.

When sending an overall image, that is to say when supplying the data to all of the processor units, those messages which have the longest path are in this case sent first of all, as explained above, in conjunction with the description of the theoretical graph principles.

This routing table then also results directly in the routing duration, with which the routing trees are assessed.

During further operation with the display, a pixel image can be sent in a very simple manner with the aid of the pixel numbers and the previously described routing tables. To do this, a portal processor sends messages of the measurement RGB type provided with the following parameters:
the number of the pixel which is addressed, and
the color information for this pixel, for example red, green, blue values.

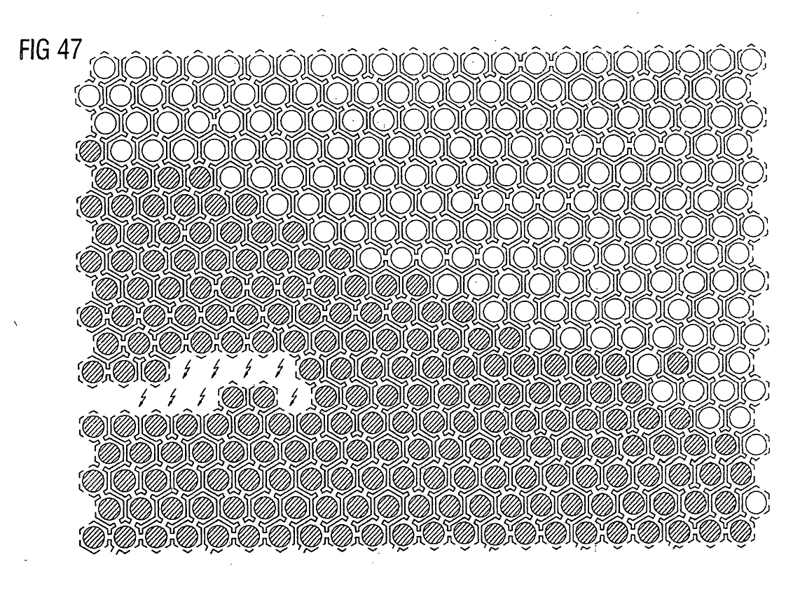

FIG. 47 illustrates an example of how an image is displayed on the pixel arrangement. The display is, of course, independent of the chosen routing tree.

The selection and the assessment of routing matrices have been described above, that is to say essentially of routing paths. In this case, the assessment criterion is the routing duration. Since an actual combinational optimization process normally cannot be carried out in a short time owing to the complexity, an alternative has been described above.

The freely variable parameter is the weight g. The portal processor can easily carry out this process several times with a different weight g for (partial) optimization of the routing duration.

The weights g=0, 1, 2, 3, . . . are normally considered and investigated.

These have been found to be advantageous for numerical analysis purposes. That routing which has the shortest routing duration can then finally be used.

In order to make it possible to carry out the process repeatedly, the portal processor uses the measurement retry message, which deletes all the channels, color regions and color distances, as is illustrated in FIG. 48. In order to terminate the process, the measurement retry message is provided with the parameter “stamp” whose value is not identical to the corresponding stored parameter in the processor unit. In other words, the portal processor uses a different parameter “stamp” whenever resetting takes place.

On reception of an incoming measurement retry message 4801 with the parameter “stamp”, the respective processor unit receiving the measurement retry message 4801 carries out the following steps:
1. If its own stamp parameter is identical to the stamp parameter “stamp” contained in the measurement retry message, the processing is ended.
2. Its own stamp parameter is set to the value of the stamp parameter value “stamp”, contained in the measurement retry message.
3. All of the numberings, channels, color regions, color distances and token blockings are deleted.
4. Additional measurement retry messages 4802 are transmitted via all the connections with the exception of the connection to the processor unit sending the measurement retry message, as illustrated in FIG. 48.

During operation of the pixel arrangement, usage can results in faults which were not yet apparent at the time at which the self-organization process described above was carried out. Further messages may be used for self-identification of these faults.

On the basis of the model assumptions described above, a fault can exist from the viewpoint of a local processor, only when an adjacent processor which has been connected until then can no longer be accessed. In contrast, it cannot assess whether only the connection to this adjacent processor or whether the adjacent processor itself has failed. However, when an event such as this occurs, a fault message, which is referred to in the following text as a measurement error message, can be sent to the portal processor, which message self-identifies the portal processor, using its own pixel number as a message parameter and additionally contains the number of the newly failed connection.

One possible reaction of the portal processor to a message such as this is a global reset of the pixel arrangement with the aid of a measurement reset message.

In reaction to this message, each pixel processor passes this message onto all of the adjacent processors, and deletes all the data which has been determined during the organization process. Each pixel processor should comply with a specific dead time, before the end of which it does not react to any further messages, in order to terminate this process. The dead time prevents the processing of the measurement reset message being repeated indefinitely.

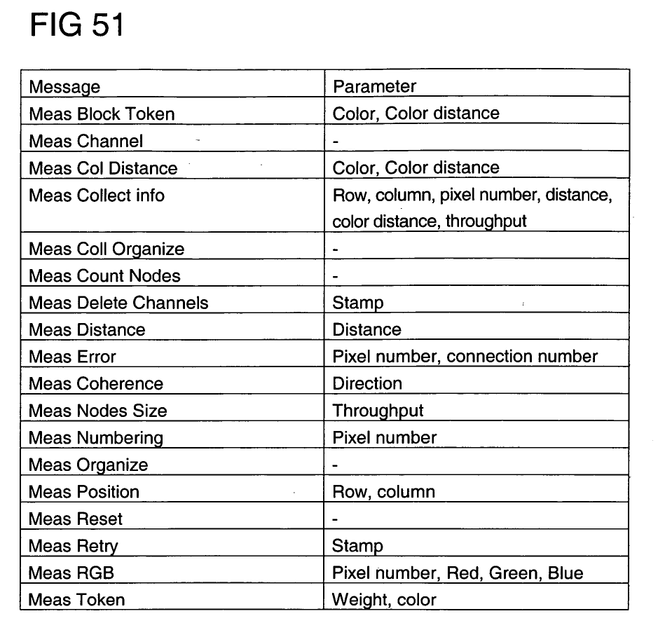

In summary, FIG. 51 illustrates an overview of the messages which are used, showing their respective parameters.

In this context, it should be noted that the message catalog may, of course, be functionally extended by adding any desired additional messages.

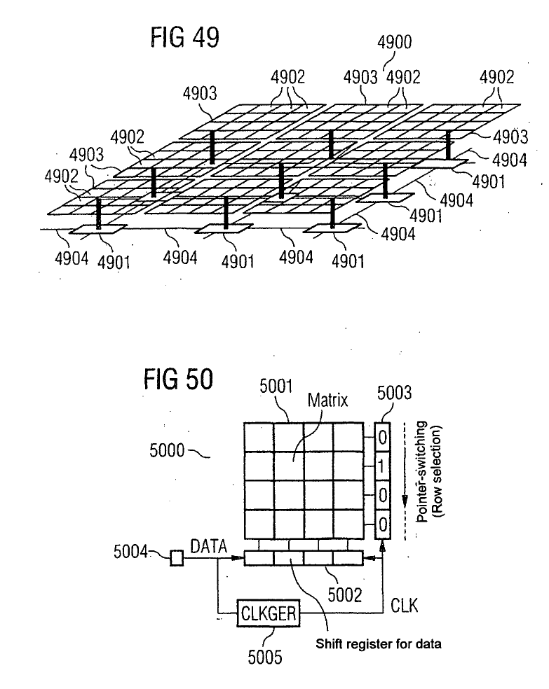

FIG. 49 illustrates an additional exemplary embodiment of the invention, in which the processor units 4901 are arranged in the form of a matrix in a first hierarchy level, and are completely networked to one another. The processors 4901 in the pixel arrangement 4900 in this case have a quadrilateral, a square shape, and are coupled for control and reading purposes to a respective group of pixels, that is to say image points or sensor elements.

According to this exemplary embodiment, each processor is for control and/or reading purposes coupled to 4*4 pixels 4902, which are in each case grouped to form a pixel block 4903.

The individual pixel group processors are networked to one another, as described above in an orthogonal network by means of local next-adjacent connections 4904.

One or more connections may run between any two processors 4901, in order, for example, to allow bidirectional data transmission or else the separate distribution of the supply voltages. As explained above, the layer of the pixels 4902 contains the individual pixel elements, with each pixel block 4903 being driven by means of a conventional matrix drive, as is illustrated by way of example in FIG. 50.

The matrix controller 5000 in FIG. 50, has, by way of example, a pixel block 5001 as well as a column addressing unit, which is in the form of a shift register 5002, as well as a row addressing unit 5003, which is likewise in the form of a shift register. The data is supplied via a data source 5004 to the input of the shift register 5001 of the column addressing unit, into a clock generation unit 5005, whose output side is coupled to the input of the column addressing unit 5003.

This keeps the vertical wiring complexity between the two levels, the processor level and the pixel level simple, since only one serial data transmission is carried out via only one line, and with the clock signals also being obtained from the data signal itself.

In this context, it should be noted that there may be more than two levels, that is to say groups of pixel group processors may in turn be combined to form groups, thus resulting in a deeper hierarchical tree structure.

The pixel group processors may be orthogonally networked to one another as in the figure, although other networking systems are likewise also possible, in particular hexagonal networking, as explained above.

Furthermore, the pixel group processors may interchange their messages in any desired formats. However, they interchange message blocks with one another which, for example, may contain address codes, with the aid of which the image information contained in the data packets can subsequently be passed from one processor to another. This also makes it possible to bypass defects in the matrix, which is not possible in the case of rigid x/y addressing via row lines and column lines.

Depending on the performance of the pixel group processors, they may also carry out other tasks in addition to information transmission and information distribution, such as compression or decompression of image information.

The architecture may also be used for large-area sensor arrays, such as fingerprint sensors, touchpads or script identification sensors.

For example, it is possible for each pixel group processor to wait for an event, that is to say an input using a pin etc., to occur in a pixel group with this data then being sent or routed to the edge of the respective matrix. This makes it possible to avoid the necessity for an external addressing unit to always scan the entire sensor area. This obviously corresponds to local triggering by an event instead of global image evaluation.

By way of example, the pixel group processors may be incorporated in a suitable mounting substrate, such as that described according to the first exemplary embodiment, with the aid of a technique such as fluidic self-assembly, as is described in J. S. Smith, High-Density, low parasitic direct Integration by Fluidic Self-Assembly (FSA), IEDM, pages 201-204, 2000.

The connections between the processors, as well as the sensor or display matrices, may then be applied in further process steps to the mounting substrate with the processors.

The above functional layers can be produced in a preferred manner by means of circuits which can be printed, such as those provided for polymer electronics.

It should be noted that the method elements described above may all be carried out independently of one another, that is to say autonomously. They each require only the input information that is required for that particular method element. However, in principle, it is irrelevant how the required input information has been determined. Nevertheless, the considerable advantages involved with the interleaving and joint implementation of several or all of the method elements should be mentioned, since, in this case, the concept according to the invention and as described above is implemented on a general basis.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, the functional circuit 52, 54, 56, and 58 of FIG. 4 are illustrated with logic circuits that one skilled in the art will recognize can be implemented in many various configurations while still achieving the objects of the present invention. This application is intended to cover any adaptations or variations of the specific embodiments discussed herein. Therefore, it is intended that this invention be limited only by the claims and the equivalents thereof.

1-12. (canceled)

13. A method for determining the distance between processor units and at least one reference position in a processor arrangement having a multiplicity of processor units, wherein each processor unit is coupled by a bidirectional communication interface to at least one adjacent processor unit, and wherein messages are interchanged between mutually adjacent processor units, the method comprising:
producing a first message by a first processor unit, wherein the first message contains first distance information including the distance between a processor unit and a reference position;
sending the first message from the first processor unit to the second processor unit;
determining the distance between the second processor unit and the reference position as a function of the first distance information;
producing a second message by a second processor unit, wherein the second message contains second distance information including the distance between a processor unit and the reference position;
sending the second message from the second processor unit to the third processor unit; and
determining the distance between the third processor unit and the reference position as a function of the second distance information.

14. The method of claim 13, wherein the first distance information includes the distance between the first processor unit and the reference position, and the second distance information includes the distance between the second processor unit and the reference position.

15. The method of claim 13, wherein the first distance information includes the distance between the second processor unit and the reference position, and wherein the second distance information includes the distance between the third processor unit and the reference position.

16. The method of claim 13, wherein the distance between the second processor unit and the reference position is stored as a function of the first distance information and wherein the distance between the third processor unit and the reference position is stored as a function of the second distance information.

17. The method of claim 13, wherein each processor unit sends a message to each adjacent processor unit, each message containing distance information including the distance between a processor unit and the reference position.

18. The method of claim 13, wherein each processor unit is coupled to at least one pixel, such that the at least one pixel can be controlled by the respective processor unit associated with it.

19. The method of claim 18, wherein at least some of the pixels are each in the form of a sensor.

20. The method of claim 18, wherein at least some of the pixels are in the form of an imaging element.

21. The method of claim 13, wherein the processor units are each arranged in a hexagonal area; and wherein each processor unit has six adjacent processor units that are each coupled to the processor unit via a bidirectional communication interface.

22. The method of claim 18 in which the pixels have a hexagonal shape.

23. The method of claim 13, wherein the processor units are each arranged in a rectangular area and wherein each processor unit has four adjacent processor units that are each coupled to the processor unit via a bidirectional communication interface.

24. The method of claim 18, wherein the pixels have a rectangular shape.

25. The method of claim 18, wherein the before determination of the distance between the processors and the reference position, the local positions of the processor units within the processor arrangement are determined in that position determination messages are transmitted to adjacent processor on the basis of a processor unit at an interdiction point in the processor arrangement, wherein position determination messages have at least one row parameters z and one column parameter s that respectively contains the row number and column number of the processor unit sending the message.

26. The method of claim 25 wherein the processor unit's own row number is associated with the row parameter value z of the received message when the row parameter in the received message is larger than the previously stored row number of the processor unit.

27. The method of claim 25, wherein the distance stored column number is associated with the row parameter value of the received message when the column parameter in the received message is greater than the processor unit's own column number.

28. The method of claim 25, wherein new position measurement messages with new row parameters and new column parameters are generated when a processor unit's own row number or its own column number has been changed, wherein the new row parameters and the new column parameters contain the row number and the column number of the processor unit sending the message and are transmitted to a respective adjacent processor unit via the bidirectional communication interfaces.

29. A method of claim 13, wherein each processor unit has its own distance value and wherein each processor unit's own distance value is changed using an iterative method when a previously stored distance value is greater than a received distance value increased by a predetermined value.

30. The method of claim 29, wherein a processor unit produces a distance measurement message when the processor unit changes its own distance value and sends the distance measurement message to adjacent processor units, wherein the distance measurement message contains its own distance as distance information.

31. The method of claim 30, wherein the distance value is increased by a predetermined value with respect to its own distance value.

32. A processor arrangement comprising:
a multiplicity of processor units each coupled via a bidirectional communication interface to at least one adjacent processor unit;
messages that are interchanged between mutually adjacent processor units in order to determine the respective distance between a processor unit in the processor arrangement and a reference position;
wherein each message contains distance information that indicates the distance between a processor unit and the reference position; and
means within each processor unit for determining the distance from the processor unit to the reference position from the distance information in a received message.

33. The processor arrangement of claim 32, wherein each message contains distance information that indicates the distance between a processor unit sending the message and the reference position.

34. The processor arrangement of claim 32, wherein each message contains distance information that indicates the distance between a processor unit receiving the message and the reference position.
